(19) United States
(12) Patent Application Publication
(10) Pub. No.: US 2008/0288414 A1
(43) Pub. Date: Nov. 20, 2008

(54) Sales data processor and computer readable medium

(75) Inventors: Kotaro Otsubo, Tokyo (JP); Satoshi Iwasa, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Casio Computer Co., Ltd., Tokyo (JP)

(21) Appl. No.: 12/152,014

(22) Filed: May 12, 2008

(30) Foreign Application Priority Data
May 15, 2007 (JP) 2007-129334
Jun. 27, 2007 (JP) 2007-169499

(51) Int. Cl. G06Q 10/00; H04L 9/32

(52) U.S. Cl. 705/75; 726/3; 705/30

(57) ABSTRACT

A sales data processor connected to a server device via a communication network. A connection unit connects to the sales data processor a recording medium which has stored access information on the server device and identification information on the sales data processor. A CPU reads the access information and the identification information stored in the recording medium. A communication unit is authenticated by the server device based on the read access destination information and identification information to communicate with the server device.

### BACKGROUND OF THE INVENTION

1. Field of the Invention

The present invention relates to sales data processors and computer readable mediums which are used in various stores for processing sales data.

2. Background Art

In a state where a cell phone or television set is connected to the Internet, it is difficult to acquire access information on destinations such as URLs (Uniform Resource Locators), using an input device with fewer keys such as a numeral key unit/remote control unit of the cell phone or television set than a keyboard of a PC (Personal Computer). Recently, it is possible to connect a cell phone or a television set to the homepage of a destination, using a storage medium such as a memory card or IC card where access information on the destination is stored, instead of inputting the access information, using an input device (for example, as disclosed in Published Unexamined Japanese Patent Applications TOKKAI 2002-108737 and -312325 and 2006-323537).

Sales data processors such as an ECR (Electronic Cash Register) are set up in many stores such as commodity sales stores or eating houses to process the sales data. The sales data processor is limited in the number of keys and in the use of an input device thereof compared to a PC. Thus, when a store uses various services provided over a communications network such as the Internet, it is difficult for the store to input access information on a destination, using the input device of the sales data processor. In order to overcome this problem, it is considered to access a server device, using a recording medium where access information on the destination is stored, as described above. However, the sales data processors are originally limited in use and function. Thus, even when the sales data processor can connect to the server device, a mechanism which uses information provided by the server device is not actually established.

Recently, settling systems have diffused in which settlement terminals set up in the respective stores are connected via a communication network to a settlement center, thereby performing an electronic settlement (see, for example, Published Unexamined Japanese Patent Applications TOKKAI 2006-268211 and 350687). POS (Point Of Sale) systems have also diffused in which sales data processors such as ECRs set up in the respective stores are connected via a network such as private lines to a server device to cause the same to collect sales data for the respective stores.

However, the settlement system and the POS system each compose an independent network. Thus, when both systems are introduced for use, great expense is required and hence it is especially difficult for small-scaled stores to introduce those systems.

It is an object of the present invention to connect sales data processors easily to a server device via a communications network, thereby allowing communication with the server device.

It is another object of the present invention to connect a settlement terminal and a server device via a sales data processor such that a single communication unit can send each of the sales data and the settlement data to the server device.

### SUMMARY OF THE INVENTION

According to a first aspect of the present invention, there is provided a sales data processor connected to a server device via a communication network, the sales data processor comprising: a connection unit which connects to the sales data processor a recording medium which has stored access information on the server device and identification information on the sales data processor; reading means for reading the access information and the identification information stored in the recording medium; and a communication unit authenticated by the server device based on the read access destination information and identification information to communicate with the server device.

According to a second aspect of the present invention, there is provided a software program product embodied in a computer readable medium, the program causing a computer to operate as: connection means for connecting thereto a recording medium which has stored access information on a server device connected to a sales data processor via a communication network and identification information on the sales data processor; reading means for reading the access information and the identification information stored in the recording medium; and communication means authenticated by the server device based on the read access information and identification information to communicate with the server device.

According to a third aspect of the present invention, there is provided a sales data processor connected via a communication network to a server device, the sales data processor comprising: a communication unit which communicates with the server device via the communication network; a connection unit which connects the sales data processor to a settlement terminal which produces settlement data; a storage unit which stores sales data received in each transactions; first control means, responsive to an electronic settlement command, for sending the received sales data to the settlement terminal via the connection unit and for receiving the settlement data produced by the settlement terminal via the connection unit; second control means for causing the communication unit to send the settlement data received via the connection unit to the server; third control means for receiving from the communication unit information on approval of the settlement sent by the server device via the communication unit and for sending the received information on approval to the settlement terminal via the communication unit; registering means for storing the sales data in the storage unit based on the information on approval received via the connection unit from the settlement terminal; and fourth control means for sending the sales data stored in the storage unit to the server device via the communication unit.

According to a fourth aspect of the present invention, there is provided a software program product embodied in a computer readable medium, the program causing a computer to operate as: means, responsive to an electronic settlement command, for sending sales data to a settlement terminal connected to the computer by connection means and for receiving settlement data produced by the settlement terminal via the connection unit; means for causing communication means to send the settlement data received via the connection means to the server; means for receiving via the communication means information on approval/disapproval of settlement sent by the server device and for sending the received information on approval/disapproval to the settlement terminal via the communication means; means for causing sales data received in each transactions to be stored in storage means based on the information on approval/disapproval received via the connection means from the settlement terminal; and means for sending the sales data stored in the storage means to the server device via the communication means.

### BRIEF DESCRIPTION OF THE DRAWINGS

The accompanying drawings, which are incorporated in and constitute a part of the specification, illustrate presently preferred embodiments of the present invention and, together with the general description given above and the detailed description of the preferred embodiments given below, serve to explain the principles of the present invention in which:

FIG. 1 illustrates an entire composition of a settlement system according to one embodiment of the present invention;

FIG. 2 is a block diagram of a main portion of a sales data processor according to the embodiment;

FIG. 3 is a block diagram of a main portion of a settlement terminal according to the embodiment;

FIG. 4 shows a flowchart of an opening process which will be performed under control of a CPU of the sales data processor when a store concerned opens its day's business and a flowchart of a process which will be performed by the settlement terminal;

FIG. 5 shows a flowchart continuing to FIG. 4 which will be performed by the sales data processor and a flowchart of a process which will be performed by an information center sever in conjunction with the opening process of the sales data processor;

FIG. 6 shows a flowchart continuing to FIG. 5;

FIG. 7 shows flowcharts continuing to FIG. 6 which will be performed by the sales data processor and the information center server, and a flowchart of a process which will be performed by the settlement center server in conjunction with the process of the sales data processor;

FIG. 8 shows a flowchart continuing to FIG. 7 which will be performed by the sales data processor and a flowchart of a process continuing to FIG. 4 which will be performed by the settlement terminal;

FIG. 9 shows a flowchart of an automatic process which will be performed at predetermined intervals of time after the opening process has started under control of the CPU of the sales data processor and a flowchart of a process which will be performed by the information center server in conjunction with the process of the sales data processor;

FIG. 10 shows a flowchart continuing to FIG. 9;

FIG. 11 shows a flowchart of a closing process which will be performed under control of the CPU of the sales data processor when the store ends its day's business and a process which will be performed by the settlement terminal in conjunction with the closing process of the sales data processor;

FIG. 12 shows a flowchart continuing to FIG. 11 which will be performed by the sales data processor and a flowchart of a process which will be performed by an information center sever in conjunction with the process of the sales data processor;

FIG. 13 shows a flowchart continuing to FIG. 12;

FIG. 14 shows a flowchart continuing to FIG. 13 which will be performed by the sales data processor and a flowchart continuing to FIG. 11 which will be performed by the settlement terminal;

FIG. 15 show a flowchart continuing to FIG. 14 which will be performed by the sales data processor and a flowchart continuing to FIG. 13 which will be performed by the information center server;

FIG. 16 shows a flowchart continuing to FIG. 15 and a flowchart continuing to FIG. 14 which will be performed by the settlement terminal;

FIG. 17 shows a flowchart of a process which will be performed by the sales data processor;

FIG. 18 shows a flowchart of a settlement process which will be performed by the sales data processor and a flowchart of a process which will be performed by the settlement terminal in conjunction with the settlement process of the sales data processor;

FIG. 19 shows a flowchart continuing to FIG. 18;

FIG. 20 shows a flowchart continuing to FIG. 19 which will be performed by the sales data processor and flowcharts which will be performed by the information center server and the settlement center server in conjunction with the process of the sales data processor;

FIG. 21 shows a flowchart continuing to FIG. 20 which will be performed by the sales data processor and a flowchart continuing to FIG. 19 which will be performed by the settlement terminal;

FIG. 22 shows a flowchart of a daily settlement process which will be performed by the sales data processor and a flowchart of a process which will be performed by the information center server in conjunction with the settlement process of the sales data processor;

FIG. 23 shows a flowchart continuing to FIG. 22 which will be performed by the sales data processor and a flowchart of a process which will be performed by the settlement terminal in conjunction with the process of the sales data processor;

FIG. 24 shows a flowchart continuing to FIG. 23 which will be performed by the sales data processor and a flowchart of a process which will be performed by the information center server in conjunction with the process of the sales data processor; and

FIG. 25 shows a flowchart continuing to FIG. 24 which will be performed by the sales data processor and a flowchart continuing to FIG. 23 which will be performed by the settlement terminal.

### DETAILED DESCRIPTION OF THE PRESENTLY PREFERRED EXEMPLARY EMBODIMENTS

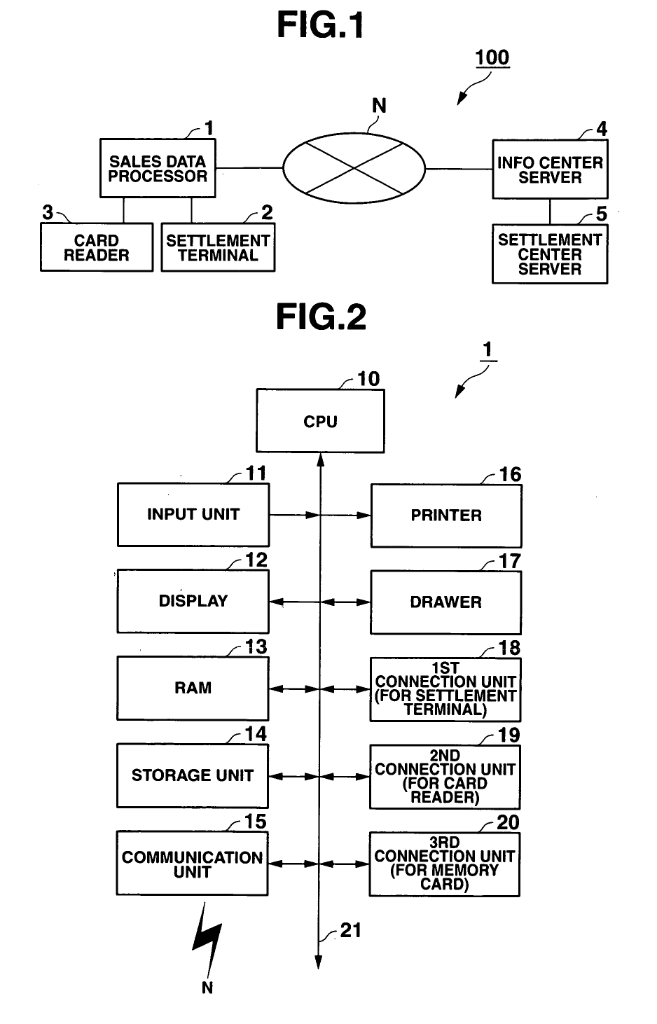

Referring to FIG. 1, an entire composition of a settlement system 100 according to one embodiment of the present invention is shown. As shown, the settlement system 100 comprises a sales data processor 1 such as an ECR (Electronic Cash Register), a settlement terminal 2 connected to the settlement data processor 1, a card reader 3 connected to the sales data processor 1, an information center server 4, and a settlement center server 5 connected to the information center server 4.

The sales data processor 1 and the information center server 4 are connected via a communication network N such as the Internet. The communication network N may comprise a VPN (Virtual Private Network).

A plurality of sales data processors 1 set up in stores are connectable to one information center server 4. One or more sales data processors may be set up in a single store. While FIG. 1 shows that the card reader 3 is connected to the sales data processor 1, the card reader 5 may be connected to the settlement terminal 2.

The information center sever 4 has the function of collecting sales data such as the names and sales amounts of commodities from the sales data processor 1 via the communication network N and supporting the respective stores using the collected data, and the function of causing the settlement center server 5 to process settlement data such as a card number, a card valid term and payment data received from the settlement terminal 2 via the sales data processor 1.

In order to perform these functions, the information center server 4 comprises a store management database, a service database, a store support database and an electronic settlement database (not shown).

The store management database has stored electronic register codes to identify the sales data processors 1 set up in the respective stores, and electronic settlement terminal codes to identify the settlement terminals 2 connected to the respective sales data processors 1. The service database has stored authentication data on services such as opening passwords, and distribution data on services including a prompt sales report and on center messages including general notices which the service database provides to the sales data processors 1 of the respective stores. The store support database has stored set up data, message inspection data and sales adjustment management data for the sales data processors 1 set up in the respective stores. The electronic settlement database has stored data on electronic settlement received from the settlement terminals 2 via the sales data processors 1.

The settlement center server 5 is connected with a CAFIS™ (Credit And Finance Institution System) which expedites credit card settlement, credit card settlement companies, the stores which have set up the sales data processors therein, and financial institutions in a network such that the settlement center server 5 provides to the sales data processors 1 various services on credit card settlement which are provided by the CAFIS.

The composition of a main portion of the sales data processor 1 is shown in FIG. 2. As shown, the sales data processor 1 comprises a CPU (Central Processing Unit) 10, an input unit 11, a display 12, a RAM (Random Access Memory) 13, a storage unit 14, a communication unit 15, a printer 16, a drawer 17, a first connection unit 18 which connects the settlement terminal 2 to the processor 1, a second connection unit 19 which connects the card reader 3 to the processor 1, a third connection unit 20 which connects a memory card to the processor 1. These elements are connected via a bus 21.

The CPU 10 reads a control program stored in the storage unit 14 and loads it on the RAM 13 to perform various processes.

More particularly, when the sales data processor 1 uses store support services provided by the information center server 4, the CPU 10 reads out an electronic register code to identify its sales data processor 1 and a store support port number from a memory card α connected to (or inserted into) the third connection unit 20 and then causes the communication unit 15 to connect the sales data processor 1 to the store support port of the information center server 4 based on the read store support port number. When the sales data processor 1 uses the electronic settlement service provided by the information center server 4, the CPU 10 receives from the settlement terminal 2 an electronic settlement terminal code to identify the electronic settlement terminal 2 concerned and an electronic settlement port number stored on a memory card β connected to (or inserted into) the settlement terminal 2 and then causes the communication unit 15 to be connected to the electronic settlement port of the information center server 4 based on the electronic settlement port number.

The input unit 11 comprises a mode switch which selects an operation (i.e., registration, adjustment, inspection, refund or setting) mode of the sales data processor 1, a cash/deposit key, an electronic settlement key which gives a command to perform electronic settlement, numeral keys which input numerical values, character keys which input characters, and a connection button key which gives a command to achieve communicable connection to the information center server 4 and provides an operation signal to the CPU 10 when a corresponding key is operated.

The display 12 comprises, for example, an LCD (Liquid Crystal Display) which performs a required display process in accordance with a display control signal from the CPU 10.

The RAM 13 has a program storage area where a control program to be executed by the CPU 10 is loaded. The RAM 13 temporarily stores in the working area thereof received data and data resulting when the control program is executed. The RAM 13 also comprises a sum memory where sales data is summed up and stored in each transactions.

The storage device 14 is composed of a HDD (Hard Disc Drive) or a non-volatile semiconductor memory which stores the control program to be executed by the CPU 10 and data required when the control program is executed.

The communication unit 15 provides control over a communicable connection of the sales data processor 1 to the information center server, 4 via the communication network N. The communication unit 15 establishes a communication link between the sales data processor 1 and the information center server 4 based on a global IP address stored on the memory card a connected to the third connection unit 20, and then performs communications with the information center server 4 based on a private IP address allocated by the information center server 4.

The printer 16 comprises, for example, a thermal printer which prints out the names of commodities sold and corresponding amounts of money as a detailed statement on respective receipt and journal paper in accordance with a print control signal received from the CPU 10 and then the resulting receipt and journal are handed over to a customer concerned and held by the store concerned, respectively, as recording the contents of the sales transactions.

The drawer 17 is for storing cash such as coins/bills therein and released by a signal from the CPU 10 due to operation of the input unit 11 (such as depression of the cash/deposit key).

The first connection unit 18 has terminals for serial connection of the sales data processor 1 to the settlement terminal 2, thereby sending/receiving data between the sales data processor 1 and the settlement terminal 2. The second connection unit 19 has connection terminals by which the card reader 3 is connected to the sales data processor 1 such that a contact or non-contact type reader/writer of the card reader reads a magnetic or IC cash or credit card, thereby receiving read data from the card reader 3.

The third connection unit 20 is composed of a connector/receptacle to which the memory card α is connected. The memory card α has stored thereon an electronic register code as information to identify the sales data processor 1, and access information on the destinations to which information center server 4 is connected, including a global IP address of the information center server 4 and port numbers which include terminal management port numbers and store support port numbers, for various services provided by the information center server 4. The CPU 10 reads access information on a selected one of the destinations stored on the memory card α, thereby accessing the information center server 4.

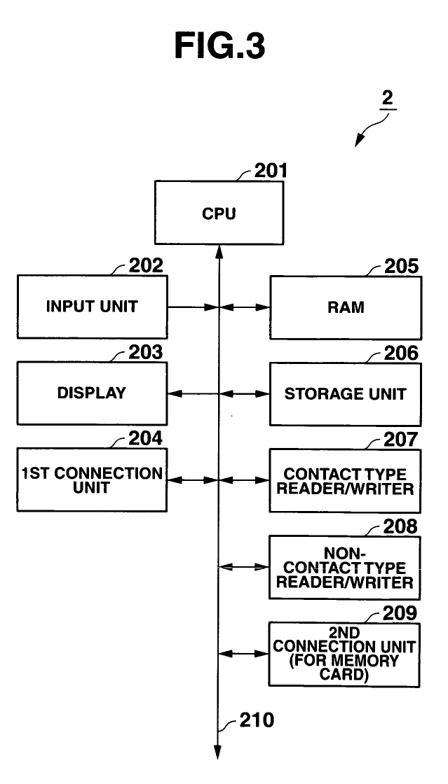

Referring to FIG. 3, the composition of a main portion of the settlement terminal 2 is shown which comprises a CPU 201, an input unit 202, a display 203, a connection unit 204 which connects the sales data processor 1 to the settlement terminal 2, a RAM 205, a storage unit 206, a contact type reader/writer 207, a non-contact type reader/writer 208, a second connection unit 209 which connects a memory card to the settlement terminal 2. These elements are connected via a bus 210.

The CPU 201 reads a control program stored in the storage unit 206 and loads it on the RAM 205 to perform various processes.

The input unit 207 comprises functional keys such as numerical keys to output an operational signal to the CPU 201 when a corresponding key is depressed.

The display 203 comprises, for example, an LCD to perform a required display process in accordance with a display control signal from the CPU 201.

The first connection unit 204 has connection terminals for serial connection of the settlement terminal 2 to the sales data processor 1 to send/receive data to/from the sales data processor 1.

The RAM 205 loads on a storage area thereof the control program Xto be executed by the CPU 201. The RAM 205 temporarily stores in a working area thereof received data and other data resulting when the control program is executed. The RAM 205 stores transactions data (such as settlement data, information on approval/disapproval of transactions by electronic settlement) occurring when the electronic settlement is performed, data of a DLL (Dynamic Link Library) and negative data received from the settlement center server 5 via the sales data processor 1.

The DLL has stored a plurality of high general-purpose programs each of which is in the form of a part as a file and read as required into a memory and used in common by a plurality of applications. The DLL data in the electronic settlement contains, for example, data on payment with a bonus which varies from credit card company to credit card company and data on the number of times of revolving repayment.

The storage unit 206 is, for example, composed of a HDD or non-volatile semiconductor memory which stores the control program to be executed by the CPU 201 and data required when the control program is executed.

The contact type reader/writer 207 has contact terminals with which an IC card as a recording medium which has built in a contact type IC chip is brought into contact, thereby allowing the reader/writer 207 to read data such as the card number and valid card term stored on the IC card/write data to the IC card.

When a recording medium which has built in a non-contact type IC chip is within a distance from the non-contact type reader/writer 208 where data can be read/written from/to the recording medium, the non-contact type reader/writer 208 reads/writes data wirelessly from/to the recording medium. Recording mediums of this type may include a portable terminal such as a cell phone or a PDA which has built in a non-contact type IC chip having a credit function.

The second connection unit 209 is composed of a connector/receptacle to which a memory card β is connected. The memory card β has stored an electronic settlement terminal code as identification information for the settlement terminal 2, and an electronic settlement port number based on which the sales data processor 1 is connected to the electronic settlement port.

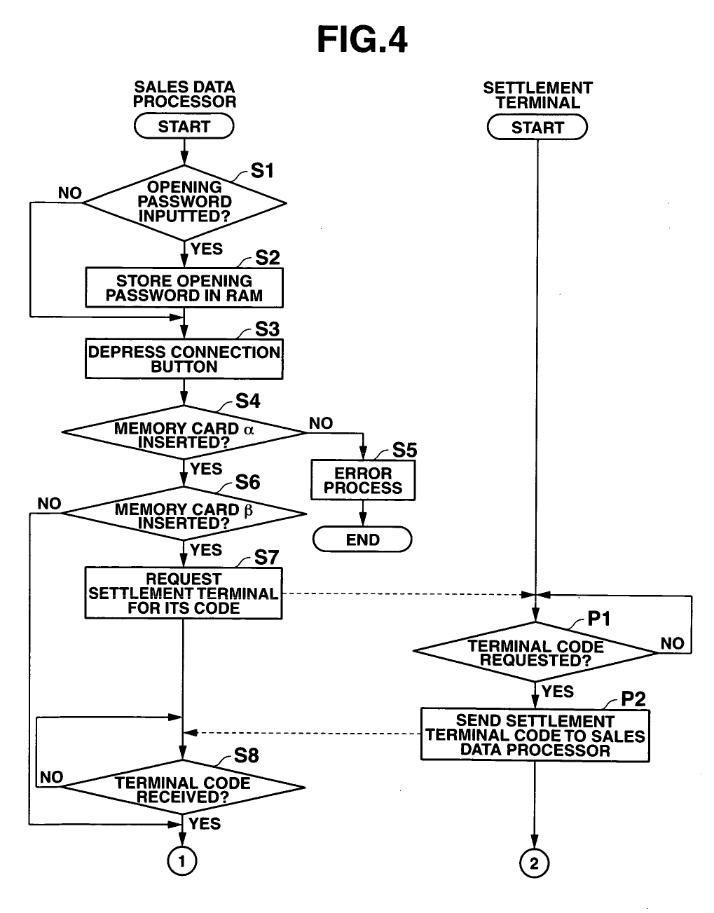

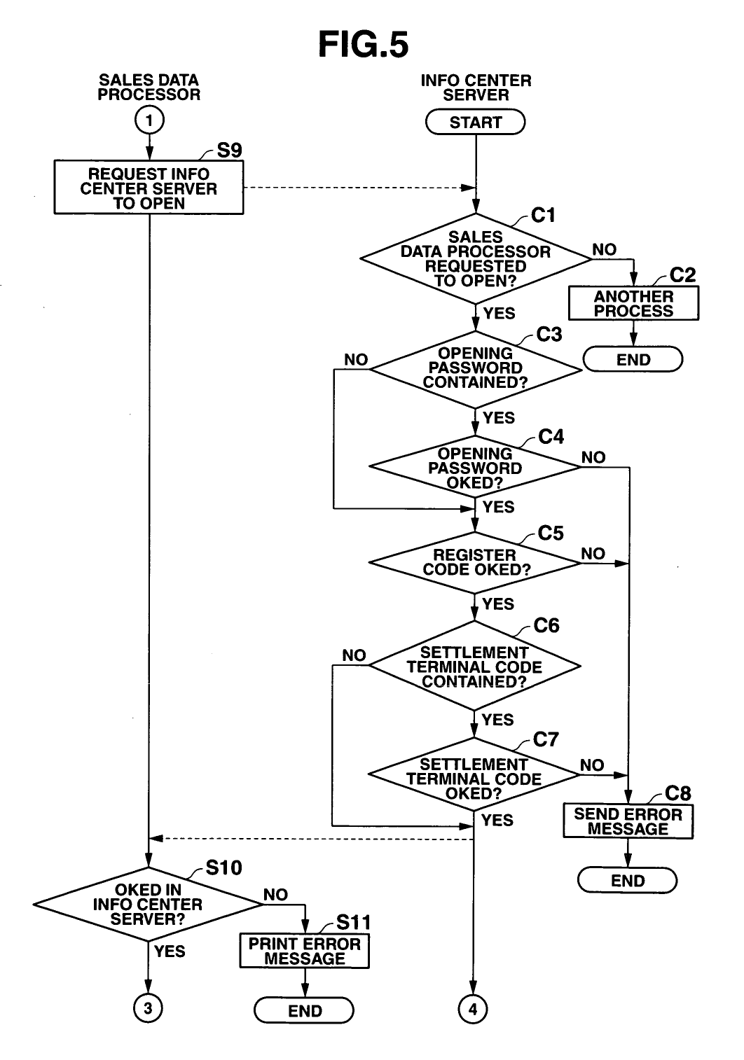

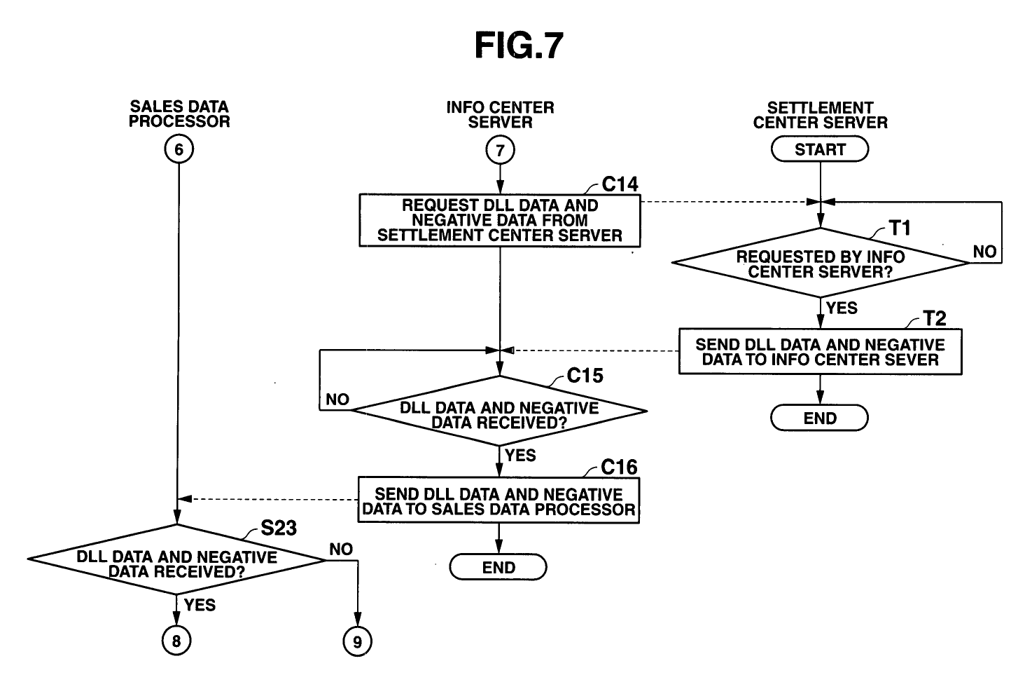

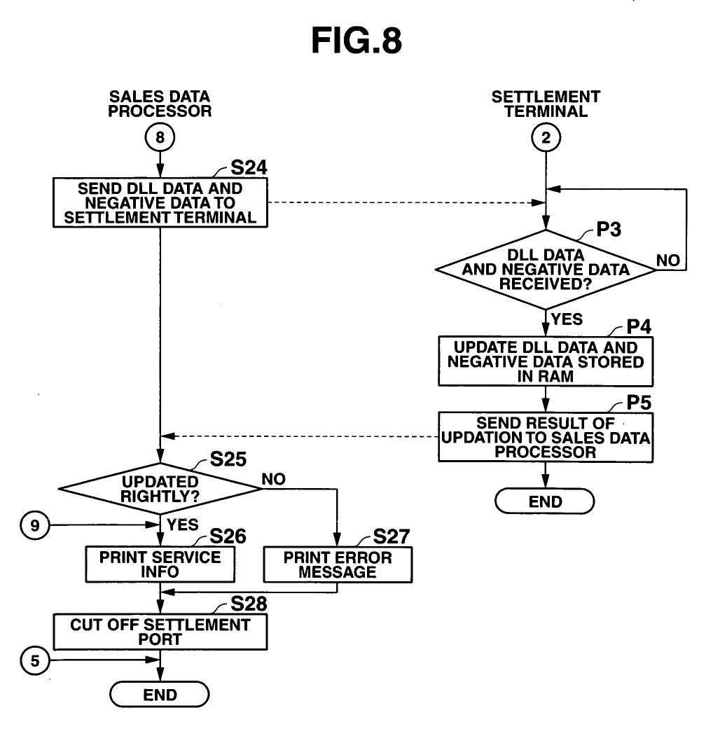

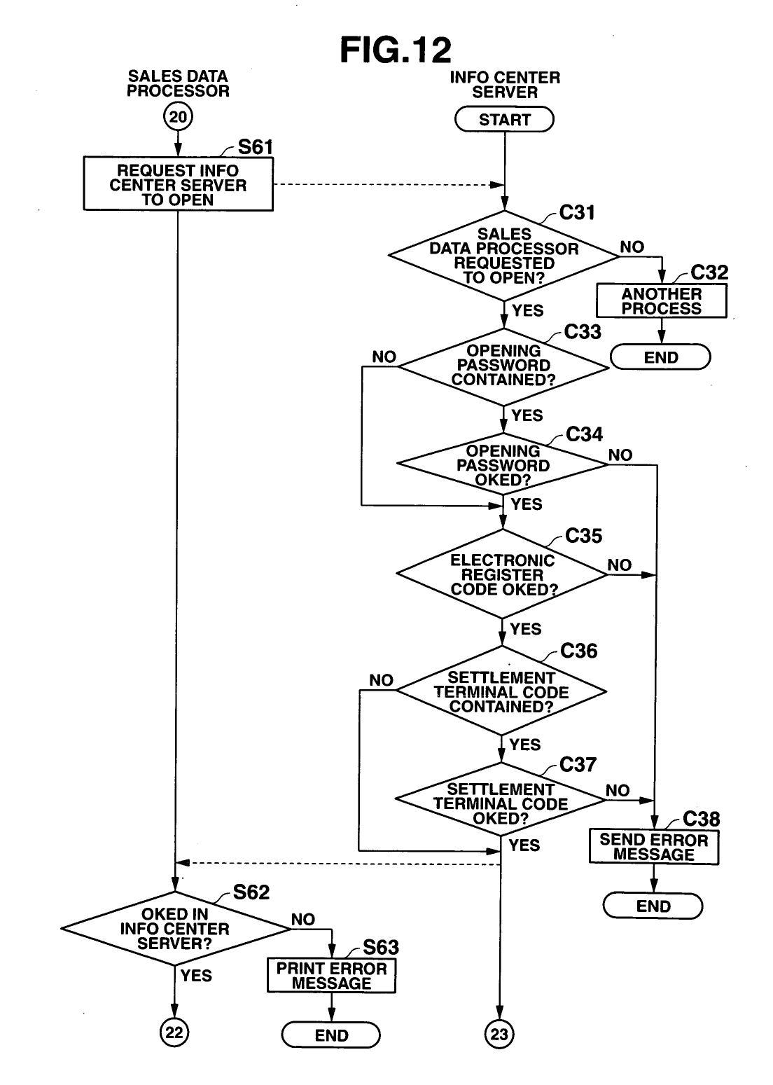

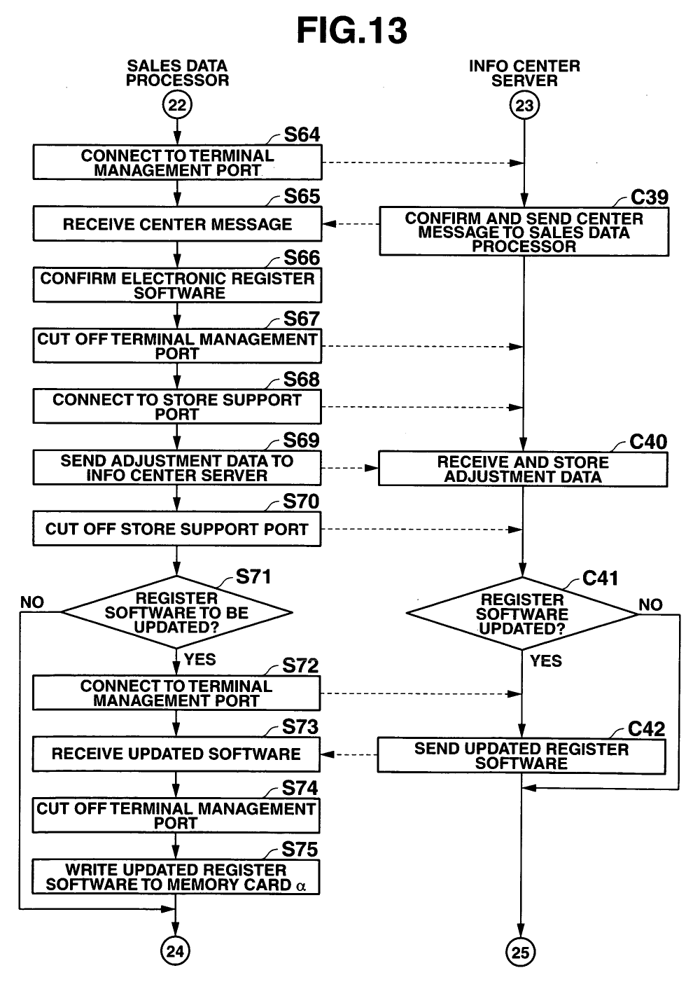

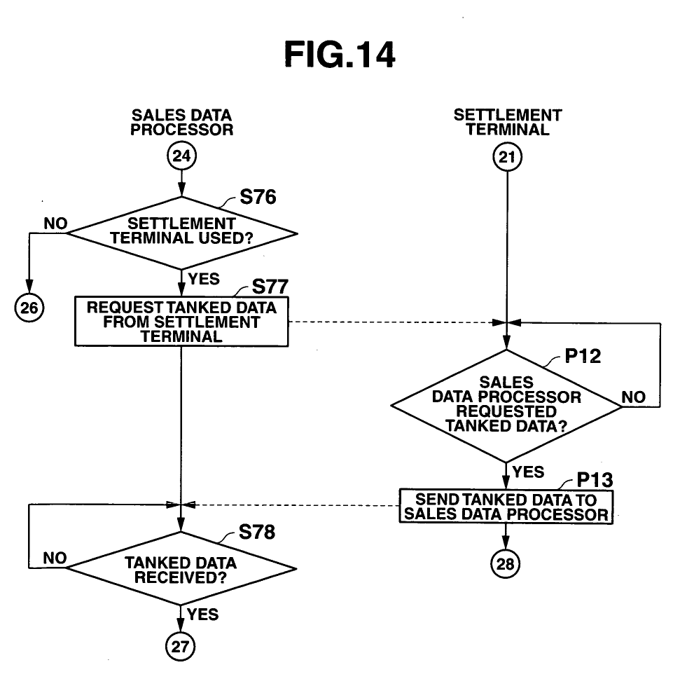

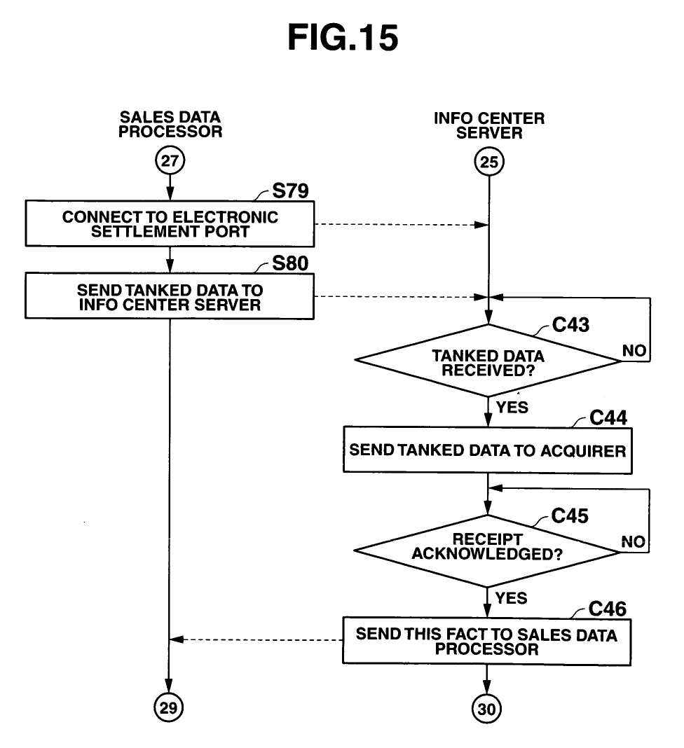

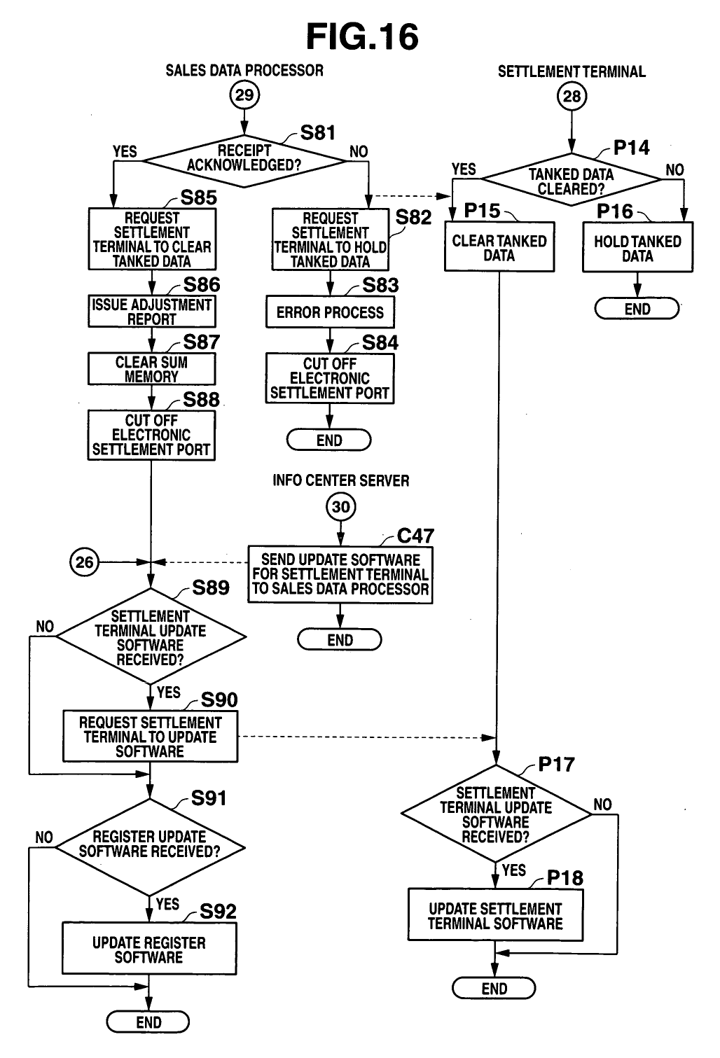

Then, referring to FIGS. 4-16, operation of this embodiment will be described. First, referring to the flowcharts of FIGS. 4-8, description is made to an opening process to be performed under control of the CPU 10 of the sales data processor 1 when the store starts its day's business and processes to be performed by the settlement terminal 2, the information center sever 4 and the settlement center server 5 in conjunction with the opening process of the sales data processor.

In the sales data processor 1, when an opening password is inputted at the input unit 11 (YES in step S1), it is stored in the RAM 13 (step S2). Then, when the connection button of the input unit 11 is depressed after step S2, or without the opening password being inputted (step S3), it is determined whether the memory card α is inserted into the third connection unit 20 (step S4).

If it is determined in step S4 (NO in step S4) that no memory card α is inserted, then an error process is performed (step S5), thereby terminating the opening process. If it is determined in step S4 (YES in step S4) that the memory card α is inserted, then it is determined whether a memory card β is inserted into the settlement terminal 2 (step S6).

If it is determined in step S6 (YES in step S6) that the memory card β is inserted, then the settlement terminal 2 is requested to send its code to the sales data processor 1 (step S7). If it is determined in step S6 (NO in step S6) that no memory card β is inserted, then the process goes to step S9, which will be described later.

If the settlement terminal 2 is required by the sales data processor 1 to send the electronic settlement terminal code to the sales data processor 1 (YES in step P1), then the electronic settlement terminal code stored on the memory card β is read and sent to the sales data processor 1 (step P2).

If the electronic settlement terminal code is received from the settlement terminal 2 in the sales data processor 1 (YES in step S8), or if it is determined in step S6 (NO in step S6) that no memory card β is inserted, then the information center server 4 is requested to open (step S9).

More specifically, the request in step S9 is made by sending the opening password inputted in step S1, the electronic register code stored on the memory card α, and the electronic settlement terminal code received from the settlement terminal 2 to the information center server 4. When no opening password is inputted in step S1, then no opening password is transmitted. In addition, when no memory card β is inserted into the settlement terminal 2, then no electronic settlement terminal code is sent.

When the information center server 4 is not requested to open by the sales data processor 1 (NO in step C1), then a process different from the opening process is performed in the information center server 4 (step C2). When the information center server 4 is requested to open by the sales data processor 1 (YES in step C1), then it is determined whether the opening password is contained in the data received from the sales data processor 1 (step C3).

If it is determined in step C3 that the opening password is contained (YES in step C3), then an authentication process for the opening password is performed using the service database, thereby determining whether the opening password is authenticated or OKed (YES in step C4).

If so (YES in step C4), or if it is determined that no opening password is contained in step C3 (NO in step C3), then it is determined whether the electronic register code received from the sales data processor 1 is OKed, using the store management database (step C5).

If it is determined in step C5 that the electronic register code is OKed (YES in step C5), then it is determined whether the electronic settlement terminal code is contained in the data received from the sales data processor 1 (step C6).

If it is determined in step C6 that the electronic settlement terminal code is contained (YES in step C6), then it is determined whether the electronic settlement terminal code is OKed, using the store management database (step C7).

If it is determined in step C4 that the opening password is not OKed (NO in step C4), if it is determined in step C5 that the electronic register code is not OKed (NO in step C5), or if it is determined in step C7 that the electronic settlement terminal code is not OKed (NO in step C7), then an error message is sent to the sales data processor 1 (step C8), thereby terminating the process in the information center server 4.

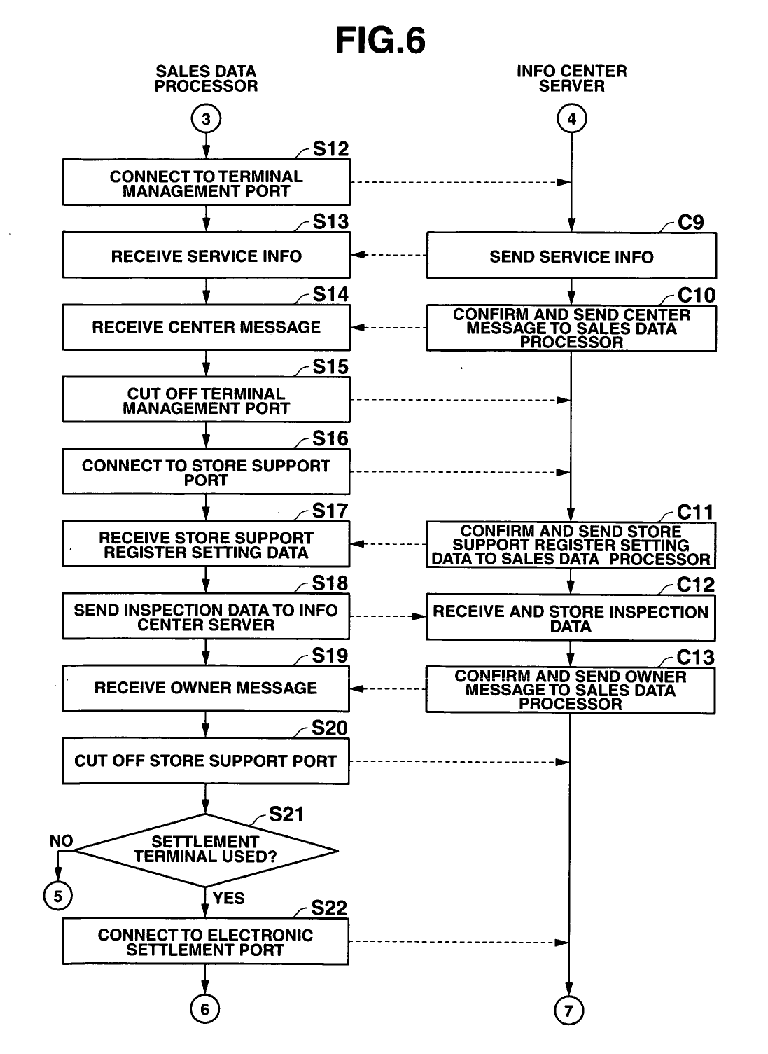

If it is determined in step C7 that the electronic register code is OKed (YES in step C7), or if it is determined in step C6 that no electronic settlement terminal code is contained (NO in step C6), then this determination is sent to the sales data processor 1 and the process goes to step C9 (FIG. 6).

In the sales data processor 1, it is determined based on the determination in step C7 received from the information center server 4 whether all the determinations are OKed (step S10). If not, or if an error message is received from the information center server 4 (NO in step S10), then the error message is printed out by the printer 16 on receipt paper (step S11), thereby terminating the opening process.

On the other hand, if it is determined in step S10 that the determinations are OKed (YES in step S10), then a terminal management port number is read from the memory card α and then the sales data processor 1 is connected to the terminal management port of the information center server 4 based on the terminal management port number (step S12).

When the sales data processor 1 is connected to the terminal management port, then, in the information center server 4 data indicative of service information stored in the service database is sent to the sales data processor 1 (step C9), and received by the sales data processor 1 (step S13).

Then, in the information center server 4, the center message stored in the service database is confirmed and then sent to the sales data processor 1 (step C10).

When the center message is received in the sales data processor 1 (step S14), the connection between the sales data processor 1 and the terminal management port is cut off (step S15), a store support port number is read from the memory card α, and then the sales data processor 1 is connected to the store support port of the information center server 4 based on the store support port number (step S16).

When the sales data processor 1 is connected to the store support port, then in the information center server 4 data for setting the store support register such as date, time, commodity names, the name of a clerk in charge, etc., stored in the store support database is confirmed in the information center server 4 and sent to the sales data processor 1 (step C11).

When the setting data on the store support register are received in the sales data processor 1 (step S17), then the sales data stored in the sales data processor 1 is sent to the information center server 4 (step S18).

In the information center server 4, the sales data is received from the sales data processor 1 and then stored in the store support database (step C12). Then, an owner message, if any, stored in the store support database is confirmed based on the sales data and then sent to the sales data processor 1 (step C13).

When in the sales data processor 1 the owner message is received from the information center server 4 (step S19), then the connection to the store support port is cut off (step S20). Then, it is determined whether the settlement terminal 2 is used (step S21).

If it is determined in step S21 that the settlement terminal 2 is not used (NO in step S21), then the opening process is terminated. If it is determined in step S21 that the settlement terminal 2 is used (YES in step S21), then the sales data processor 1 is connected to the electronic settlement port of the information center server 4 based on the electronic settlement port number stored on the memory card β in the settlement terminal 2 (step S22).

When the sales data processor 1 is connected to the electronic settlement port, the information center server 4 requests data of the DLL and negative data from the settlement center server 5 (step C14).

When the settlement center server 5 is requested to send the data of the DLL and negative data (YES in step T1), then these data are sent to the information center server 4 (step T2).

When in the information center server 4 the DLL data and negative data are received from the settlement center server 5 (Yes in step C15), then these data are sent to the sales data processor 1 (step C16).

When in the sales data processor 1 the DLL data and negative data are received from the information center server 4 (YES in step S23), then they are sent to the settlement terminal 2 (step S24).

When in the settlement terminal 2 the DLL data and negative data are received from the sales data processor 1 (YES in step P3), then the corresponding data stored so far in the RAM 205 are updated with the received DLL data and negative data (step P4) and then the updated-data are sent to the sales data processor 1 (step P5).

Then, it is determined in the sales data processor 1 whether the updated data received from the settlement terminal 2 is OKed (step S25). If so (YES in step S25), or when no DLL data and negative data are received in step S23 (NO in step S23), then the content of services provided by the information center server 4 is printed out by the printer 16 based on the service information received in step S13 (step S26).

If it is determined in step S25 that the updated data are not OKed (NO in step S25), an error message is printed out by the printer 16 on receipt paper (step S27). After step S26 or S27, the connection of the sales data processor to the electronic settlement port is cut off (step S28), thereby terminating this opening process.

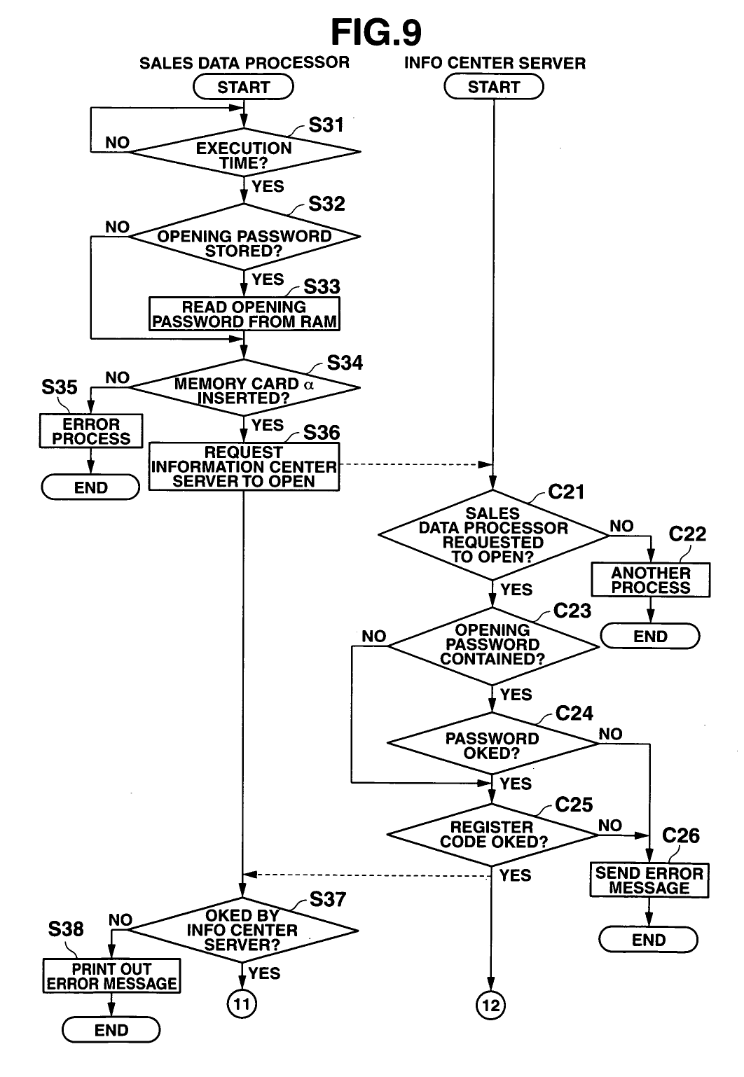

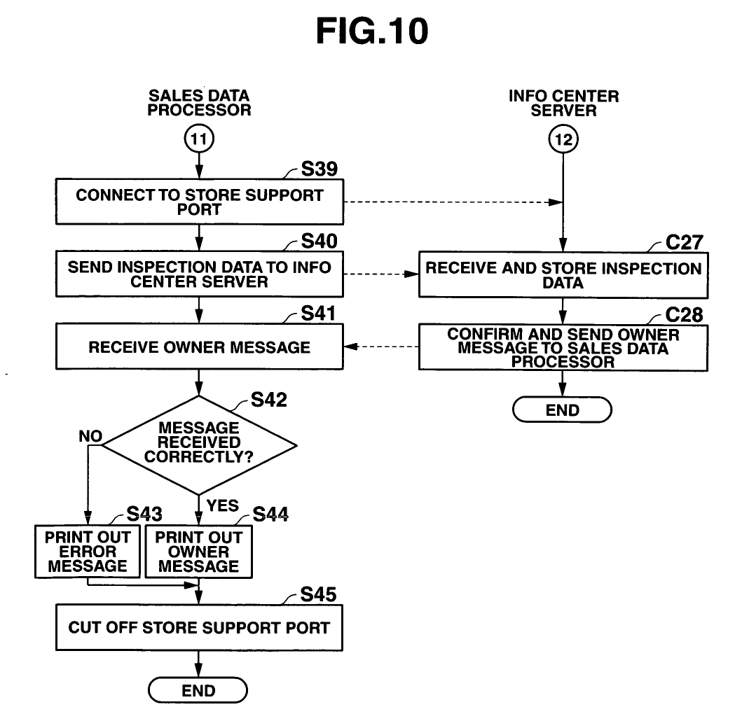

Then, referring to the flowcharts of FIGS. 9 and 10, description will be made to an automatic process to be performed under control of the CPU 10 of the sales data processor 1 at predetermined intervals of time (for example, of 30 minutes) after the sales data processor 1 has performed its opening process and a process to be performed by the information center server 4 in conjunction with the process of the sales data processor 1.

When a time when the automatic process should be performed comes in the sales data processor 1 (YES in step S31), then it is determined whether an opening password is stored in the RAM 13 (step S32). If so (YES in step S32), then the password is read from the RAM 13 (step S33).

After the step S33 or if it is determined in step S32 that no opening password is stored (NO in step S32), then it is determined whether a memory card α is inserted in the third connection unit 20 (step S34).

If not (NO in step S34), an error process is performed (step S35), thereby terminating the automatic process. If it is determined in step S34 that the memory card α is inserted (YES in step S34), then the sales data processor 1 requests the information center server 4 to open (step S36).

More specifically, in step S36 the opening request is made by sending to the information center server 4 the opening password read from the RAM 13 in step S33 and the electronic register code stored on the memory card α. When no opening password is stored in the RAM 13, then no opening password is sent in step S36.

If the information center sever 4 is not requested to open (NO in step C21), then a process different from the opening process for the sales data processor 1 is performed (step C22). If the information center sever 4 is requested to open (YES in step C21), then it is determined in the information center serer 4 whether an opening password is contained in the data received from the sales data processor 1 (step C23).

If so (YES in step C23), then it is determined whether the opening password is OKed, using the service database (step C24).

If so (YES in step C24), or if it is determined in step C23 that no opening password is contained (NO in step C23), then it is determined whether the electronic register code received from the sales data process 1 is OKed, using the store management database (step C25).

If it is determined in step C24 that the password is not OKed (NO in step C24), or if the electronic register code is not OKed in step C25 (NO in step C25), then an error message is sent to the sales data processor 1 (step C26), thereby terminating the process in the information center sever 4.

Then, it is determined in the sales data processor 1 whether all the determinations received from the information center sever 4 indicate OK (step S37). If not, or if an error message is received from the information center sever 4 (NO in step S37), the error message is printed out on receipt paper by the printer 16 (step S38), thereby terminating the automatic process.

If all the determinations indicate OK in step S37 (YES in step S37), then a store support port number is read from the memory card α and the sales data processor 1 is connected to the store support port of the information center sever 4 based on the store support port number (step S39). Then, the sales data stored in the sales data processor 1 is sent to the information center sever 4 (step S40).

When in the information center sever 4 the message inspection data is received from the sales data processor 1 after it is determined in step C25 that the electronic register code is OKed (YES in step C25), then the inspection data is stored in the store-support database (step C27). Then, an owner message, if any, stored in the store support database is confirmed based on the message inspection data and then sent to the sales data processor 1 (step C28), thereby terminating the process in the information center sever 4.

When the owner message is received from the information center sever 4 in the sales data processor 1 (step S41), then it is determined whether the owner message is correctly received (step S42). If not, an error message is printed out by the printer 16 on receipt paper (step S43).

When it is determined in step S42 that the owner message is correctly received (YES in step S42), the owner message received from the information center sever 4 is printed out by the printer 16 on receipt paper (step S44).

After the step S43 or S44, the connection from the sales data processor 1 to the store support port is cut off (step S45), thereby terminating the automatic process.

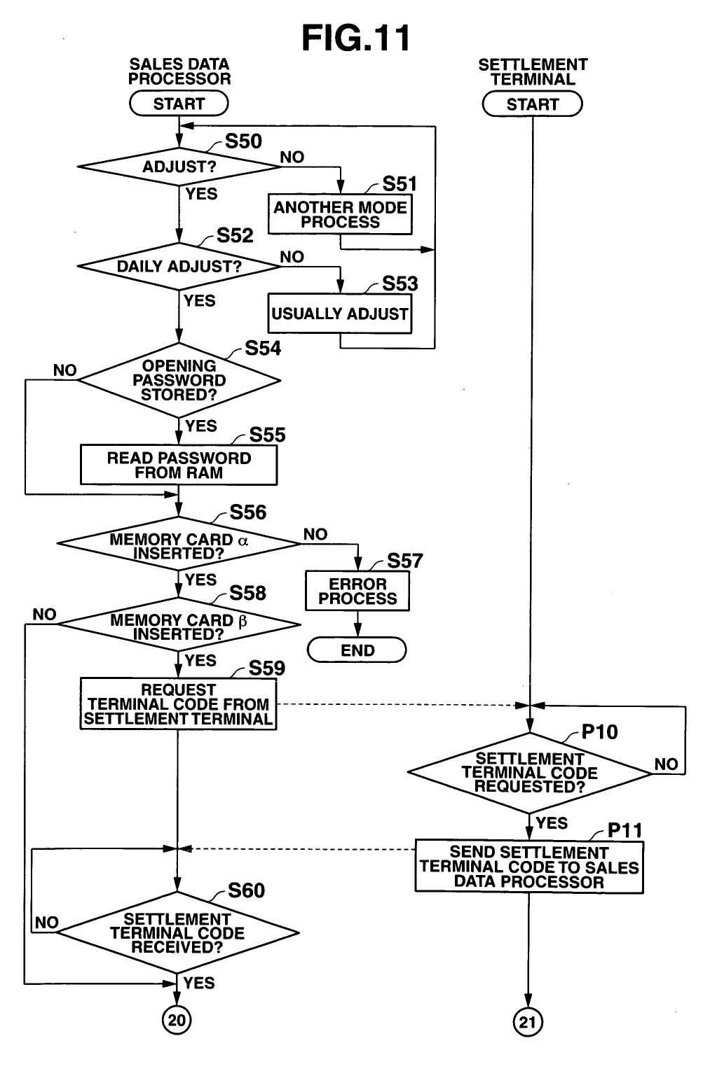

Then, referring to the flowcharts of FIGS. 11-16, description will be made to a closing process to be performed under the control of the CPU 10 of the sales data processor 1 when the sales data processor 1 closes its day's business, and processes to be performed by the settlement terminal 2 and the information center sever 4, in conjunction with the closing process of the sales data processor 1.

In the sales data processor 1, first, it is determined whether a current mode is “adjustment” (step S50). If not (NO in step S50), then another mode processes is performed (step S51).

If the current mode is determined to be “adjustment” in step S50 (YES in step S50), then it is determined whether the “adjustment” includes a daily adjustment (step S52). If not (NO in step S52), then a usual adjustment process other than the daily adjustment is performed (step S53).

If it is determined in step S52 that the adjustment includes the daily one (YES in step S52), then it is determined whether there is an opening password stored in the RAM 13 (step S54). If so (YES in step S54), the opening password is read from the RAM 13 (step S55).

After the step S55 or if it is determined in step S54 that there is no stored opening password (NO in step S54), then it is determined whether the memory card α is inserted into the connection unit 20 (step S56).

If it is determined in step S56 that no memory card α is inserted (NO in step S56), an error process is performed (step S57), thereby terminating the closing process.

If it is determined in step S56 that the memory card α is inserted (YES in step S56), then it is determined whether the memory card β is inserted in the settlement terminal 2 (step S58).

If it is determined in step S58 that the memory card β is inserted (YES in step S58), then the sales data processor 1 requests the electronic settlement terminal code from the settlement terminal 2 (step S59). If it is determined in step S58 that no memory card β is inserted (NO in step S58), then the process goes to step S61.

When the settlement terminal 2 is requested (YES in step P10), then the electronic settlement terminal code stored on the memory card β is read and sent to the sales data processor 1 (step P11).

When in the sales data processor 1 the electronic settlement terminal code is received from the settlement terminal 2 (YES in step S60), or if it is determined in step S58 that no memory card β is inserted (NO in step S58), then the sales data processor 1 requests the information center server 4 to open (step S61).

More specifically, when in step S61 the opening request is made by sending to the information center server 4 the opening password read from the RAM 13 in step S55, the electronic register code stored on the memory card α and the electronic settlement terminal code received from the settlement terminal 2. When no opening password is stored in the RAM 13 and no memory card β is inserted into the settlement terminal 2, then the opening password and electronic settlement terminal code, respectively, are not sent.

When the information center server 4 is not requested to open by the sales data processor 1 (NO in step C31), then another process different from the opening process for the sales data processor 1 is performed (step C32). When there is an opening request from the sales data processor 1 (YES in step C31), then it is determined in the information center server 4 whether the opening password is contained in the data received from the sales data processor 1 (step C33).

If it is determined in step C33 that the opening password is contained (YFS in step C33), then it is determined whether the opening password is OKed, using the service database (step C34).

If it is determined in step C34 that the opening password is OKed (YES in step C34), or if it is determined in step C33 that no opening password is contained (NO in step C33), then it is then determined whether the electronic register code received from the sales data processor 1 is OKed, using the store management database (step C35).

If so (YES in step C35), then it is determined whether an electronic settlement terminal code is contained in the data received from the sales data processor 1 (step C36).

If so (YES in step C36), then it is determined whether the electronic settlement terminal code is OKed, using the store management database (step C37). Then, the determinations in the information center server are sent to the sales data processor 1.

If it is determined in step C34 that the opening password is not OKed (NO in step C34), if it is determined in step C35 that the electronic register code is not be OKed (NO in step C35), or if it is determined in step C37 that the electronic settlement terminal code is not OKed (NO in step C37), then an error message is sent to the sales data processor 1 (step C38), thereby terminating the process in the information center server 4.

If it is determined in step C37 that the electronic settlement terminal code is OKed (YES in step C37) or if it is determined in step C36 that no electronic settlement terminal code is contained (NO in step C36), then the process goes to step C39.

In the sales data processor 1, it is determined whether all the determinations received from the information center server 4 indicate OK or authentication (step S62). If not or if an error message is received from the information center server 4 (NO in step S62), then the error message is printed out by the printer 16 on receipt paper (step S63), thereby terminating the closing process.

If it is determined in step S62 that the all determinations indicate authentication or OK (YES in step S62), then a terminal management port number is read from the memory card α and then the sales data processor 1 is connected to the terminal management port of the information center server 4 based on the terminal management port number (step S64).

When the sales data processor 1 is connected to terminal management port, then the center message stored in the service database is confirmed in the information center server 4 and sent to the sales data processor 1 (step C39).

When the center message is received by the sales data processor 1 (step S65), then a software application for the electronic register set in the sales data processor 1 is confirmed (step S66), and then the connection of the sales data processor to the terminal management port is cut off (step S67).

Then, the store support port number of the information center server 4 is read from the memory card α and the sales data processor 1 is connected to the store support port of the information center server 4 (step S68). Then, the adjustment data (or day's sales data) of the sales data processor 1 is sent to the information center server 4 (step S69).

In the information center server 4, the adjustment data is received from the sales data processor 1 and then stored in the store support database (step C40).

After the adjustment data is sent (step S69), in the sales data processor 1 the connection of the sales data processor to the store support port is cut off (step S70). Then it is determined whether there is a software application for the electronic register (step S71).

If it is determined in step S71 that there is that software application to be updated for the electronic register (YES in step S71), the terminal management port number is read from the memory card α and then the sales data processor 1 is connected to the terminal management port of the information center server 4 based on the terminal management port number (step S72).

In the information center server 4, it is determined after the step C40 whether the software application for the electronic register has been updated (step C41). If not (NO in step C41), then the process goes to step C43.

If it is determined in step C41 that the software application in the electronic register has been updated (YES in step C41) and the sales data processor 1 is connected to the terminal management port, then the updated software application for the electronic register is sent to the sales data processor 1 (step C42).

When the updated software application is received by the sales data processor 1 from the information center server 4 (step S73), the connection of the sales data processor 1 to the terminal management port is cut off (step S74). Then, the updated software application for the electronic register is written to the memory card α (step S75).

After the step S75 or if it is determined in step S71 that there is no software application to be updated for the electronic register (NO in step S71), then it is determined whether the settlement terminal 2 has been used (step S76). If not (NO in step S76), then the process goes to step S89 to be described later.

If it is determined in step S76 that settlement terminal 2 has been used (YES in step S76), then the sales data processor 1 requests tanked transactions data involving the electronic settlement from the settlement terminal 2 (step S77). The transactions data includes data on settlement, credit card number, card amount, payment in bonus/revolving repayment, etc.

When the settlement terminal 2 is requested (YES in step P12), then the data tanked in the RAM 205 is sent to the sales data processor 1 (step P13).

When the tanked data is received from the settlement terminal 2 (YES in step S78), then the sales data processor 1 is connected to the electronic settlement port of the information center server 4 based on an electronic settlement port number stored on the memory card β of the settlement terminal 2 (step S79). Then, the tanked data received from the settlement terminal 2 is sent to the information center server 4 (step S80).

When in the information center server 4 the tanked data is received from the sales data processor 1 (YES in step C43), then it is sent to an acquirer (which may be a credit card settlement company) (not shown) (step C44). When in the information center server 4 the receipt of the tanked data is acknowledged from the acquirer (YES in step C45), then data indicative of this fact is sent to the sales data processor 1 (step C46).

Then, it is determined in the sales data processor 1 whether the data received from the information center server 4 indicates acknowledgement of the receipt of the tanked data by the acquirer (step S81).

If not (NO in step S81), then the sales data processor 1 requests the settlement terminal 2 to hold the tanked data (step S82).

When the settlement terminal 2 is requested to hold the tanked data by the sales data processor 1 (NO in step P14), then it holds the tanked data stored in the RAM 205 (step P16), thereby terminating the process in the settlement terminal 2.

After the step S82, an error process is performed in the sales data processor 1 (step S83) and then the connection of the sales data processor 1 to the electronic settlement port is cut off (step S84), thereby terminating the closing process.

If it is determined in step S81 that the received data indicates acknowledgement of the receipt of the tanked data by the acquirer (YES in step S81), then the sales data processor 1 requests the settlement terminal to clear the tanked data in the RAM 205 (step S85).

When the settlement terminal 2 is requested to clear the tanked data by the sales data processor 1 (YES in step P14), then the data tanked in the RAM 205 is cleared (step P15).

After the step S85, in the sales data processor 1 an adjustment report including a receipt or journal on which the sales details sorted by section or clerk in charge are printed out by the printer 16 (step S86). Then, the sum memory of the RAM 13 is cleared (step S87), thereby cutting off the connection of the sales data processor 1 to the electronic settlement port (step S88).

After the step C46, an update software application for the settlement terminal 2 is sent from the information center server 4 to the sales data processor 1 (step C47), thereby terminating the process in the information center server 4.

In the sales data processor 1, when the update software application for the settlement terminal 2 is received or downloaded (YES in step S89), then the settlement terminal 2 is requested to update the software application (step S90).

In the settlement terminal 2, when the request is received from the sales data processor 1, it is determined whether the update software application for the settlement terminal 2 has been received or downloaded (step P17). If not (NO in step P17), then the process in the settlement terminal 2 is terminated. If it is determined in step P17 that the update software application has been received (YES in step P17), the software application for the settlement terminal 2 is updated with the received update software application (step P18), thereby terminating the process in the settlement terminal 2.

After step S90 or when no update software application for the settlement terminal 2 has bees received in step S89 (NO in step S89), the sales data processor 1 determines whether the update software application for the electronic register has been received or downloaded (step S91).

If so (YES in step S91), then the software application for the electronic register is updated with the software application written to the memory card α in step S75, thereby terminating the closing process.

If it is determined in step S91 that no update software application for the electronic register has been received (NO in step S91), the closing process is terminated without the software application for the electronic register being updated.

As described above, according to the sales data processor 1 of the embodiment, the sales data processor 1 is easily connected to the information center server 4 based on the destination access information (including the global IP address and port number) stored on the memory card, thus becoming communicable with the information center server 4, and renders information provided by the information center server 4 available. Especially, the sales data processor 1 becomes communicable with the information center server 4 with a simple operation including depression of the connection button switch of the input unit 11.

A user or sales clerk of the sales data processor 1 can easily acquire the content of services provided by the information center server 4 by printing it on receipt paper.

The user or sales clerk can acquire the content of the latest services which the information center server 4 provides by connecting the sales data processor 1 to the information center server 4 not only when the store is opened but also at predetermined intervals of time.

In the sales data processor 1 of the present embodiment, in order to eliminate restrictions on IDs and passwords, thereby enhancing flexibility, the electronic register code to be stored in the recording medium may be set either by the user or produced and designated by ASPs.

Further, according to the sales data processor 1 of the embodiment, the electronic register code is stored on the memory card. Thus, when the electronic register into which the memory card is inserted malfunctions, the memory card may be removed from the register and then inserted into another normal register for operating purposes. That is, a quick response is possible in terms of maintenance. Therefore, even when the register is required to be replaced with another for maintenance/repair purposes, the recording medium is only required to be moved into the substitute without resetting required information. In contrast, since in the conventional POS systems such information is stored in the register, it requires resetting.

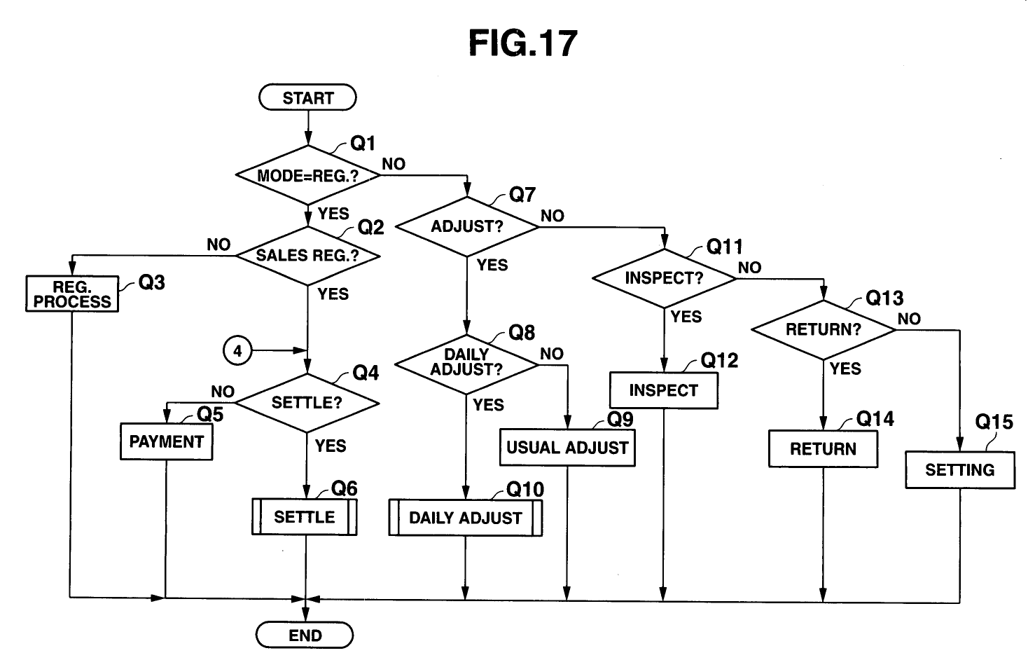

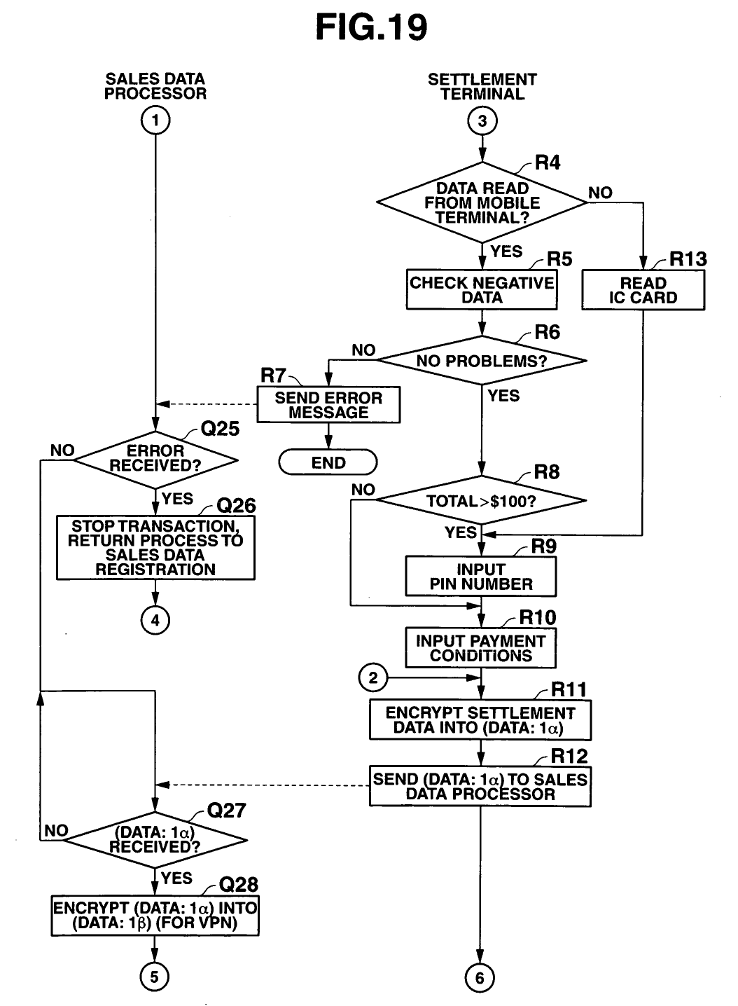

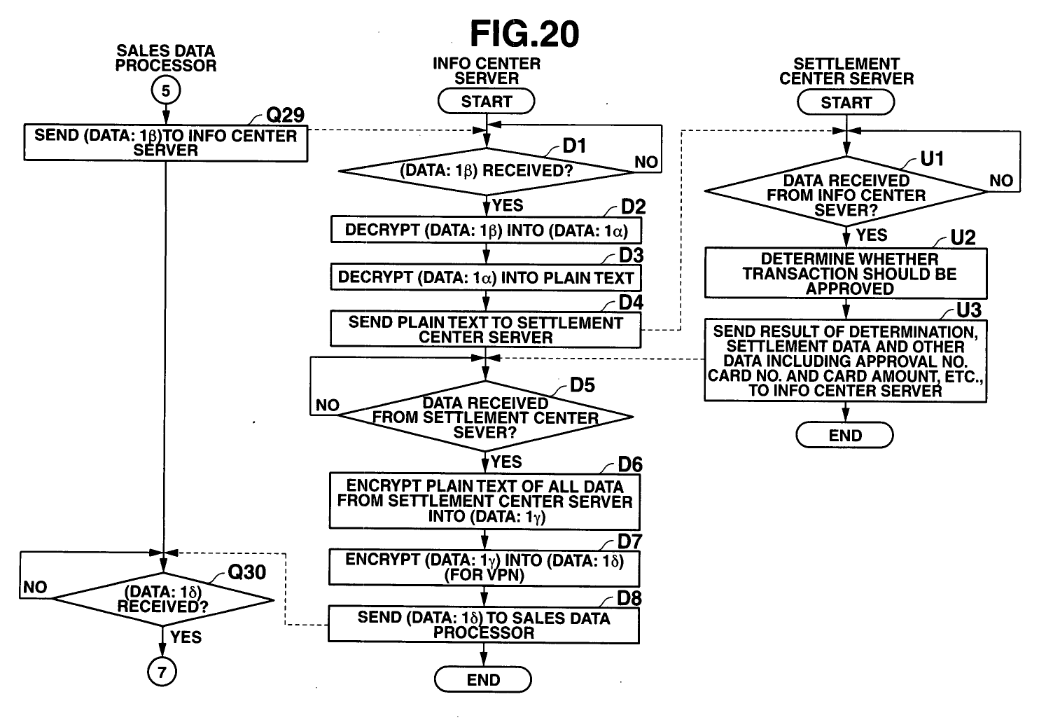

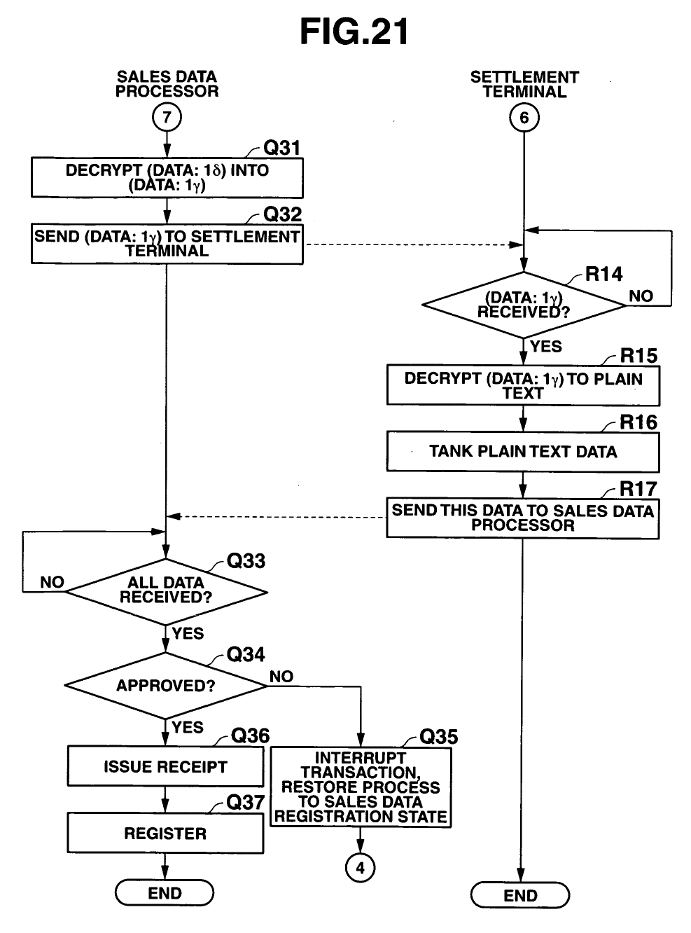

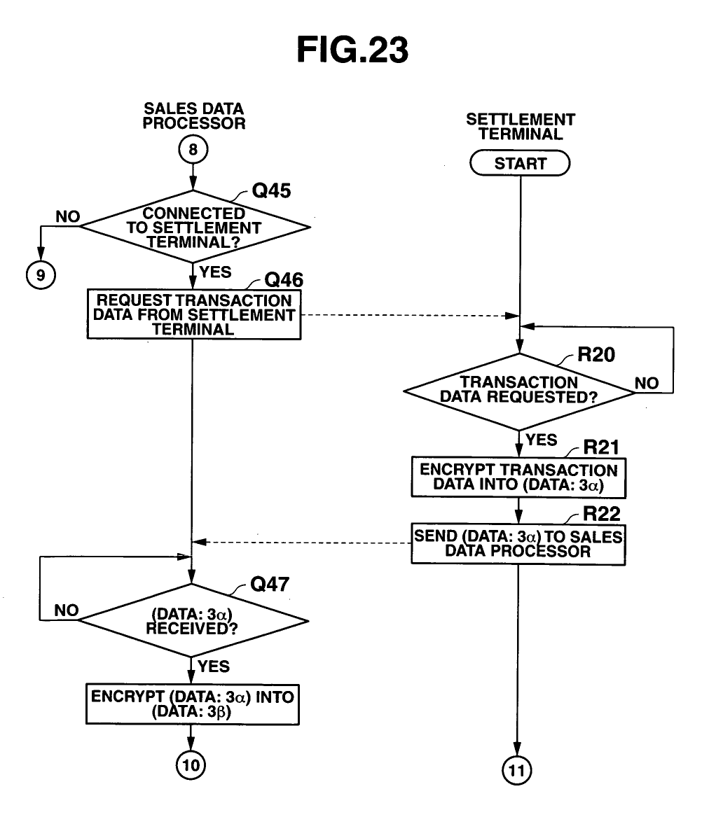

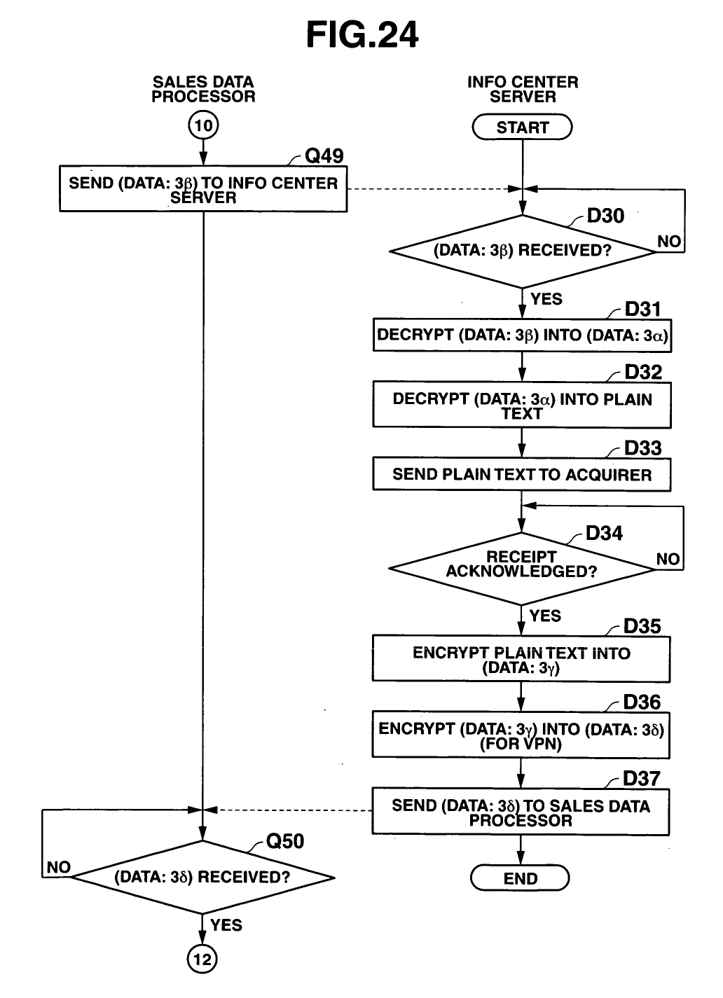

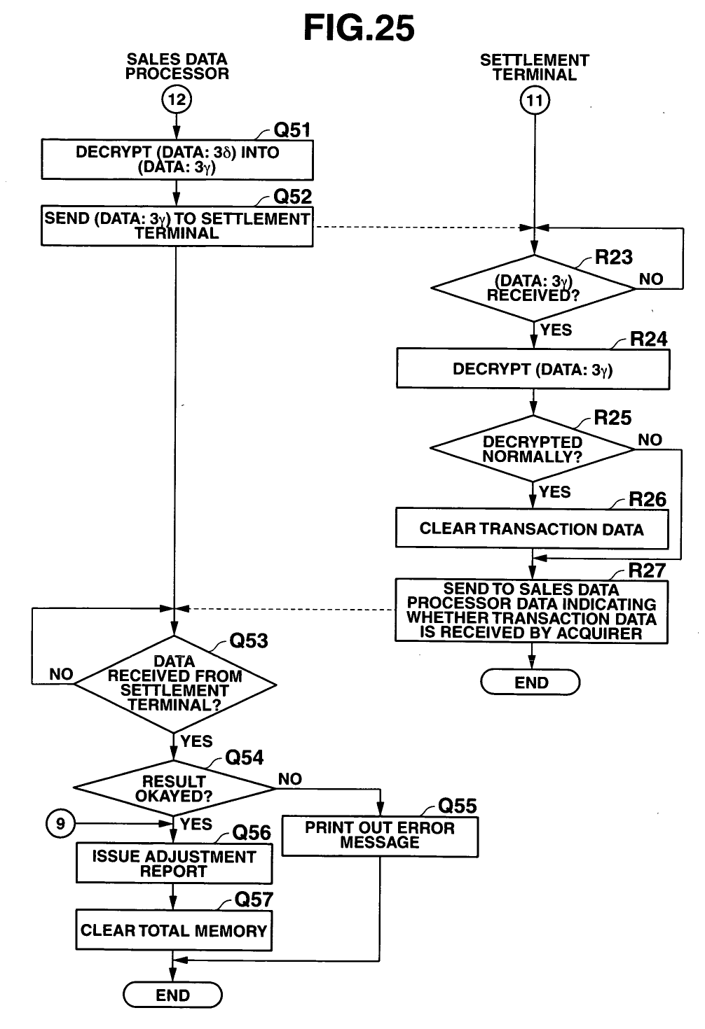

Then, referring to the flowcharts of FIG. 17-25, operation of a second embodiment is described. First, in the flowchart of FIG. 17, a flow of a process of the second embodiment to be performed under control of the CPU 10 of the sales data processor 1 (FIG. 1) is described.

First, it is determined whether a current mode of the sales data processor 1 is “registration” (step Q1). This determination is performed by referring to by referring to a set position of a mode switch or the set content of a mode setting memory (not shown), for example provided in the storage unit 14 of FIG. 2, and rewritable by operating a mode key of the input unit 11. When it is determined in step Q1 that the current mode is “registration” (YES in step Q1), then it is determined whether the “registration” indicates sales registration (step Q2).

If not (otherwise, if it indicates, for example, “registration of receipt of money or money changing”) (NO in step Q2), then a registration process other than the “sales registration” is performed (step Q3). If it is determined in step Q2 that the “registration” indicates “sales registration” (to be performed, for example, when a customer has purchased commodities) (YES in step Q2), then the sales registration is performed (not shown) and it is determined whether a payment by electronic settlement is commanded by operating an electronic settlement key of the input unit 11 (step Q4).

If not (NO in step Q4), then a payment process (for example, with cash) other than that by the electronic settlement is performed (step Q5), and the sales data is added to the total memory of the RAM 13.

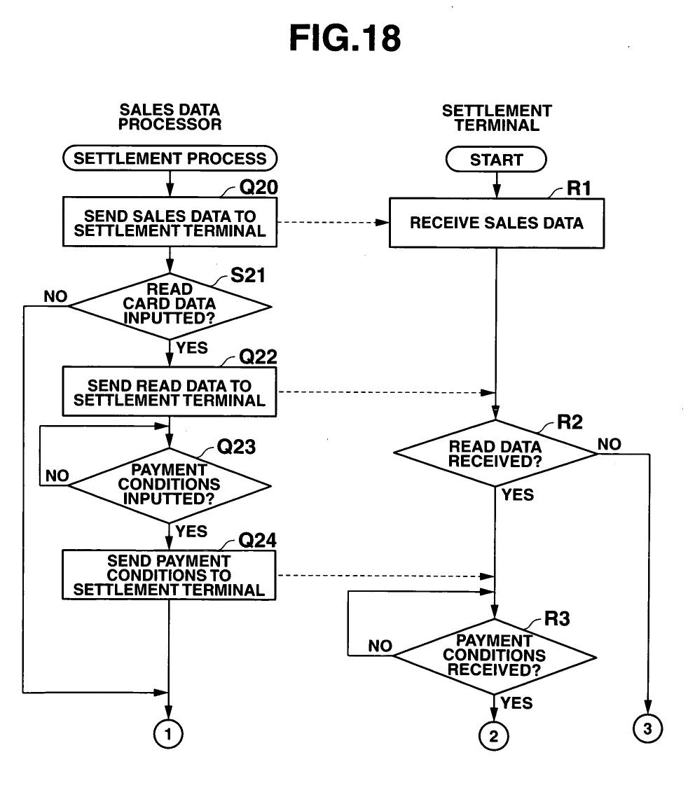

If it is determined in step Q4 that the payment by the electronic settlement is commanded (YES in step Q4), then a settlement process is performed by communication with the settlement terminal 2 and the information center server 4 (step Q6), which will be described later in more detail with reference to FIG. 18-21.

If it is determined in step Q1 that the current mode is not “registration” (NO in step Q1), then it is determined whether the current mode is “adjustment” (step Q7). If so (YES in step Q7), it is then determined whether the “adjustment” indicates “daily adjustment” (step Q8).

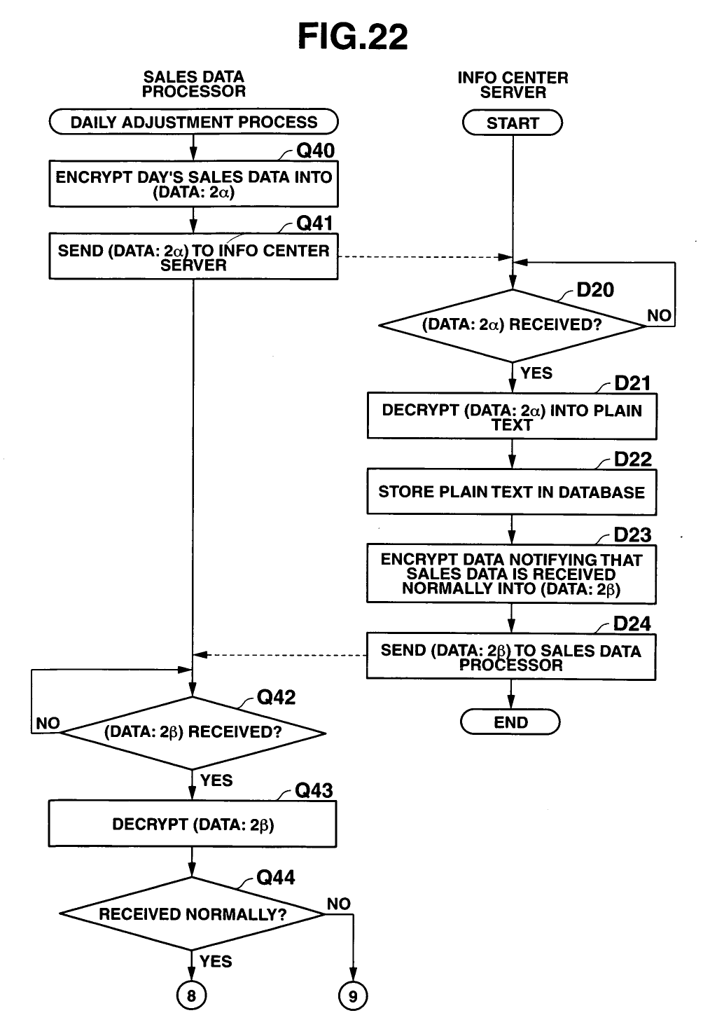

If not (NO in step Q8), a usual adjustment process other than the daily one is performed (step Q9). If it is determined in step Q8 that the “adjustment” indicates “daily adjustment” (YES in step Q8), then a “daily adjustment” process is performed by communication with the settlement terminal 2 and the information center server 4 (step Q10), which will be described later in more detail with reference to FIG. 22-25.

When it is determined in step Q7 that the current mode is not “adjustment” (NO in step Q7), then it is determined whether the current mode is “inspection” (step Q11).

If so (YES in step Q11), a message inspection process is performed (step Q12). If not (NO in step Q11), then it is determined whether the current mode is “refund” which represents cancellation of the previous process (step Q13).

If so (YES in step Q13), a refund (or cancellation) process is performed (step Q14). If it is determined in step Q13 that the current mode is not “refund” (NO in step Q13) (but that the current mode is “set”), then a set process is performed by operating keys of the input unit 11 such that, for example, date, time, commodity names, the name of a clerk in charge, etc., are set (step Q15).

Then, referring to the flowcharts of FIGS. 18-21, description will be made to a settlement process (in step Q6 of FIG. 17) to be performed under control of the CPU 10 of the sales data processor 1 when sales transactions by electronic settlement is commanded, a process to be performed under control of the CPU 201 of the settlement terminal 2, a process to be performed by the information center server 4 and a process to be performed by the settlement center server 5, wherein these processes excluding the settlement process occur in conjunction with the settlement process.

First, sales data representing a total sum for one sales transactions is sent from the sales data processor 1 to the settlement terminal 2 via the connection unit 18 (step Q20). Then, the sales data is received by the settlement terminal 2 (step R1).

After sending the sales data, in the sales data processor 1 it is determined whether data (involving a card number and a card valid term) recorded on a magnetic card are received from the card reader 3 (step Q21). If so (YES in step Q21), then the received data is sent via the connection unit 18 to the settlement terminal 2 (step Q22).

Further, if the sales data processor 1 receives payment conditions (or the number of times of payment) for the charge from the card reader 3 or the input unit 11 (YES in step Q23), then data on the payment conditions is sent to the settlement terminal 2 via the connection unit 18 (step Q24).

When in the settlement terminal 2 the read magnetic card data is received from the sales data processor 1 (YES in step R2) and data on the payment conditions is received (YES in step R3), then the process goes to step R11.

When in the sales data processor 1 no read magnetic card data is received from the card reader 3 (NO in step Q21), then the sales data processor 1 waits for reception of data from the settlement terminal 2.

When in the settlement terminal 2 the non-contact type reader/writer 208 has read settlement data (such as the user's number) from a mobile terminal having a credit function (YES in step R4) without the read magnetic card data being received (NO in step R2), the read data is checked for negative based on negative data (such as black list data) stored in the RAM 205 (step R5). The negative data will be downloaded from the information center server 4 periodically (for example, at the start of the day's business of the settlement terminal 2).

If data (including the card number and card valid term) recorded on the IC credit card are read by the contact type reader/writer 207′ (step R13), then the process goes to step R9 which will be described later.

When in the settlement terminal 2 the read data from the mobile terminal is checked for negative, then it is determined whether a result of the negative data check indicates that there are no problems (step R6). When it is determined in step R6 that there is some problem (NO in step R6), then an error message is sent to the sales data processor 1 (step R7), thereby terminating the process in the settlement terminal 2.

When in the sales data processor 1 the error message is received from the settlement terminal 2 (YES in step Q25), then the current sales transactions is stopped and a process is performed which returns the current process to the registration process directly before step Q4 of FIG. 17 (step Q26).

If in the settlement terminal 2 it is determined in step R6 that there are no problems (YES in step R6), then it is determined whether a total sum of the transactions exceeds a predetermined amount, for example, $100 based on the sales data received in step R1 (step R8).

If so (YES in step R8) or when the IC card is read in step R13, then the customer inputs his or her PIN number at the input unit 202 (step R9). Then, the store clerk or customer operates the input unit 202 to input the conditions (or the number of times) of payment of the charge (step R10).

If it is determined in step R8 that the total amount is not more than $100 (NO in step R8), then the payment conditions are required to be inputted instead of the PIN number (step R10). In the case of payment with the magnetic card, the customer is required to subscribe his or her name. Thus, the payment conditions are required to be inputted without the inputting of the customer's PIN number being requested (step R10).

Thereafter, settlement data required for approval by the settlement center server 5 are created based on the sales data and the read data (card number, card valid term, etc.) from the mobile terminal or IC card and then encrypted, for example, in an encryption system such as 3DES (Triple Data Encryption Standard) (step R11). The encrypted data is hereinafter referred to as (DATA: 1α), which is then sent to the sales data processor 1 (step R12).

When in the sales data processor 1 the encrypted data (DATA: 1α) is received via the connection unit 18 (YES in step Q27), then the (DATA: 1α) is further encrypted into data (DATA: 1β) in an encryption system such as the 3DES to cause the encrypted data to be transmitted through the VPN (step Q28).

Then, the sales data processor 1 is connected via the communication unit 15 to the information center server 4 based on the port number for the settlement service recorded on the memory card connected to the connection unit 20 thereof (or the connection unit 209 of the settlement terminal 2). Then, the encrypted data (DATA: 1β) obtained in step Q28 is sent to the information center server 4 (step Q29).

When in the information center server 4 the encrypted data is received (DATA: 1β) (YES in step D1), then it is decrypted into the data (DATA: 1α) (step D2). Then, the data (DATA: 1α) is further decrypted into settlement data of a plain text (step D3). Then, this settlement data is sent to the settlement center server 5 (step D4).

When in the settlement center server 5 the settlement data is received from the information center server 4 (YES in step U1), then it is determined whether the transactions should be approved based on the settlement data (step U2). Then, a plain text indicative of a result of the determination in step U2, the settlement data and other required data are sent from the settlement center server 5 to the information center server 4 (step U3). When the transactions is approved, the other required data contains an approval number.

In the information center server 4, when the data is received from the settlement center server 5 (YES in step D5), then the received data is encrypted into the data (DATA: 1γ) in an encryption system such as the 3DES (step D6).

Then, in the information center server 4, further the ciphered data (DATA: 1γ) is encrypted into data (DATA: 1δ) in an encryption system such as the 3DES for transmission through the VPN (step D7), and then this data (DATA: 1δ) is sent to the sales data processor 1 via the communication network N (step D8).

In the sales data processor 1, when the data (DATA: 1δ) is received. (YES in step Q30), then this data is decrypted into the data (DATA: 1γ) (step Q31) and sent to the settlement terminal 2 via the connection unit 18 (step Q32).

In the settlement terminal 2, when the data (DATA: 1γ) is received (YES in step R14), it is decrypted to a plain text (step R15). Then, resulting transactions data, which includes the settlement data, other required data, etc., is tanked (or stored) in the RAM 205 (step R16), and then sent to the sales data processor 1 (step R17).

In the sales data processor 1, when the data is received via the connection unit 18 (YES in step Q33), then it is determined based on that data whether the transactions should be approved (step Q34). If not (NO in step Q34), the transactions is stopped and the process is performed which returns the current process to the sales registration directly before step Q4 of FIG. 17 (step Q35).

If it is determined in step Q34 that the transactions should be approved (YES in step Q34), the details of the sales, the approval number and a part of the card number are printed out on receipt paper, thereby issuing a corresponding receipt (step Q36). Then, a registration process is performed which includes addition of section-sorted sales data to that in the total memory of the RAM 13 (step Q37), thereby terminating the settlement process.

Then, referring to the flowcharts of FIGS. 22-25, description will be made to a daily adjustment process (step Q10 of FIG. 17) to be performed under control of the CPU 10 of the sales data processor 1 when a daily adjustment is commanded at the end of the day's business, a process to be performed under control of the CPU 201 of the settlement terminal 2, and a process to be performed in the information center server 4. The processes excluding the daily adjustment process occur in conjunction with the daily adjustment process.

In the sales data processor 1, the day's sale data including a total amount is read from the total memory of the RAM 13 and then encrypted in an encryption system such as the 3DES, thereby producing an encrypted data (DATA: 2α) (step Q40):

Then, a port number for the store support service provided by the information center server 4 is read from the memory card connected to the connection unit 20 and then the sales data processor 1 is connection to the information center server 4 based on the port number via the communication unit 15. Then, the encrypted data (DATA: 2α) is sent to the information center server 4 (step Q41).

In the information center server 4, when the encrypted sales data (DATA: 2α) is received (YES in step D20), then it is decrypted into a plain text (step D21) and then stored in the store support database (not shown) (step D22).

Then, data informing that the sales data is normally received is encrypted into data (DATA: 2β) in an encryption system such as the 3DES (step D23), and then this data is sent to the sales data processor 1 via the communication network N (step D24).

In the sales data processor 1, when the data (DATA: 2β) is received (YES in step Q42), then it is decrypted (step Q43). It is then determined based on this decrypted data whether the day's sales data is received normally by the information center server 4 (step Q44).

If not (NO in step Q44), the process goes to step Q56 which will be described later. If so (YES in step Q44), then it is determined whether the sales data processor 1 is connected to the settlement terminal 2 (step Q45).

If not (NO in step Q45), the process goes to step Q56 which will be described later. If so (YES in step Q45), the sales data processor 1 requests transactions data including totaled day's sales data involving the electronic settlement from the settlement terminal 2 (step Q46).

When the transactions data is requested by the sales data processor 1 (YES in step R20), then in the settlement terminal 2 the day's transactions data tanked in the RAM 205 is read and then encrypted into data (DATA: 3α) in an encryption system such as the 3DES (step R21). Then, this data is sent to the sales data processor 1 (step R22).

In the sales data processor 1, when the encrypted transactions data (DATA: 3α) is received (YES in step Q47), this data is further encrypted into data (DATA: 3β) in an encryption system such as the 3DES to cause this data to be transmitted through the VPN (step Q48).

Then, the sales data processor 1 is connected to the information center server 4 based on the port number for the settlement service. Then, the encrypted data (DATA: 3β) obtained in step Q48 is sent to the information center server 4 (step Q49).

In the information center server 4, when the encrypted data (DATA: 3β) is received (YES in step D30), then it is decrypted into (DATA: 3α) (step D31). This is further decrypted into a plain text (step D32).

This plain text is then sent to an acquirer including a credit card settlement institution (not shown) (step D33). In the information center server 4, when reception of the plain text is acknowledged by the acquirer (YES in step D34), then data indicative of this acknowledgement is encrypted into (DATA: 3γ) in an encryption system such as the 3DES (step D35).

Then, the (DATA: 3γ) is further encrypted into (DATA: 3δ) in an encryption system such as the 3DES to cause this data to be transmitted through the VPN (step D36). This data is then sent to the sales data processor 1 via the communication network N (step D37).

In the sales data processor 1, when the encrypted data (DATA: 3δ) is received (YES in step Q50), then this data is decrypted into (DATA: 3γ) (step Q51). Then, this data is sent to the settlement terminal 2 via the connection 18 (step Q52).

In the settlement terminal 2, when (DATA: 3δ) is received (YES in step R23), this data is decrypted (step R24). Then, it is determined based on the data obtained in step R24 whether the decryption was made well (step R25).

If so (YES in step R25), then the transactions data tanked in the RAM 205 is cleared (step R26). Then, the result of the determination in step R25 is sent to the sales data processor 1 (step R27). If not (NO in step R25), the result of the determination is sent to the sales data processor 1 without the transactions data tanked in the RAM 205 being cleared (step R27).

In the sales data processor 1, when the result of the determination in step R25 is received from the settlement terminal 2 (YES in step Q53), then it is determined whether the processing has ended normally (step Q54). If not (NO in step Q54), an error message is printed out by the printer 16 on receipt or journal paper (step Q55), thereby terminating the day's adjustment process without the total memory of the RAM 13 being cleared.

If it is determined in step Q54 that the receipt of the plain text was acknowledged by the acquirer (YES in step Q54), an adjustment report is issued including a receipt or journal on which the details of section/clerk in charge-sorted sales data are printed by the printer 16 (step Q56). Then, the total memory of the RAM 13 is cleared (step Q57), thereby terminating the daily adjustment process.

As described above, according to the present embodiment, the sales data processor 1 functions to relay communications between the settlement terminal 2 and the information center server 4 such that each of the sales data and the settlement data is sent to the information center server 4 by the single communication unit 15.

By further encrypting the settlement data, which is already encrypted by the settlement terminal 2, in the sales data processor 1 for transmission through the VPN, security and communication quality are secured.

Various modifications and changes may be made thereunto without departing from the broad spirit and scope of this invention. The above-described embodiments are intended to illustrate the present invention, not to limit the scope of the present invention. The scope of the present invention is shown by the attached claims rather than the embodiments. Various modifications made within the meaning of an equivalent of the claims of the invention and within the claims are to be regarded to be in the scope of the present invention.

This application is based on Japanese Patent Applications No. 2007-169499 and 2007-129334 filed on Jun. 27, 2007 and on May 15, 2007, respectively, and each including a specification, claims, drawings and a summary. The disclosure of the above Japanese patent applications is incorporated herein by reference in its entirety.

What is claimed is:

1. A sales data processor connected to a server device via a communication network, the sales data processor comprising:
a connection unit which connects to the sales data processor a recording medium which has stored access information on the server device and identification information on the sales data processor;
reading means for reading the access information and the identification information stored in the recording medium; and
a communication unit authenticated by the server device based on the read access destination information and identification information to communicate with the server device.

2. The sales data processor of claim 1, further comprising:
an input unit that gives a command to connect communicably to the server device; and wherein:
when the input unit gives the command to connect to the server, the communication unit reads the access information and the identification information stored in the recording medium, thereby communicating with the server device.

3. The sales data processor of claim 1, wherein:
the communication unit receives service information provided by the server device, and further comprising:
a printer which prints out the received service information on a receipt.

4. The sales data processor of claim 1, wherein the communication unit communicates with the server device at predetermined intervals of time.

5. The sales data processor of claim 1, wherein:
the access information stored in the recording medium comprises a global IP address of the server device; and
the communication unit establishes a communication link between the communication unit and the server device based on the global IP address stored in the recording medium, thereby communicating with the server device based on a private IP address allocated by the server device.

6. The sales data processor of claim 1, wherein:
the server device provides one or more services to the sales data processor; and
the access information stored in the recording medium comprises one or more port numbers for the one or more services provided by the server device.

7. The sales data processor of claim 1, wherein:
the recording medium comprises a memory card connected removably to the sales data processor.

8. A software program product embodied in a computer readable medium, the program causing a computer to operate as:
connection means for connecting thereto a recording medium which has stored access information on a server device connected to a sales data processor via a communication network and identification information on the sales data processor;
reading means for reading the access information and the identification information stored in the recording medium; and
communication means authenticated by the server device based on the read access information and identification information to communicate with the server device.

9. A sales data processor connected via a communication network to a server device, the sales data processor comprising:
a communication unit which communicates with the server device via the communication network;
a connection unit which connects the sales data processor to a settlement terminal which produces settlement data;
a storage unit which stores sales data received in each transactions;
first control means, responsive to an electronic settlement command, for sending the received sales data to the settlement terminal via the connection unit and for receiving the settlement data produced by the settlement terminal via the connection unit;
second control means for causing the communication unit to send the settlement data received via the connection unit to the server;
third control means for receiving from the communication unit information on approval of the settlement sent by the server device via the communication unit and for sending the received information on approval to the settlement terminal via the communication unit;
registering means for storing the sales data in the storage unit based on the information on approval received via the connection unit from the settlement terminal; and
fourth control means for sending the sales data stored in the storage unit to the server device via the communication unit.

10. A settlement system comprising the sales data processor, the server device connected to the sales data processor via the communication unit, and the settlement terminal connected to the sales data processor via the connection unit, these units being defined in claim 9, wherein:
the settlement terminal comprises first encryption means for encrypting the settlement data in a first encryption system; and
the first control means of the sales data processor receives settlement data encrypted by the first encryption means.

11. The settlement system of claim 10, wherein:
the sales data processor comprises second encryption means for encrypting the encrypted settlement data received by the first control means in a second encryption system; and
the second control means sends the settlement data encrypted by the encryption means to the server device.

12. A software program product embodied in a computer readable medium, the program causing a computer to operate as:
means, responsive to an electronic settlement command, for sending sales data to a settlement terminal connected to the computer by connection means and for receiving settlement data produced by the settlement terminal via the connection unit;
means for causing communication means to send the settlement data received via the connection means to the server;
means for receiving via the communication means information on approval/disapproval of settlement sent by the server device and for sending the received information on approval/disapproval to the settlement terminal via the communication means;
means for causing sales data received in each transactions to be stored in storage means based on the information on approval/disapproval received via the connection means from the settlement terminal; and
means for sending the sales data stored in the storage means to the server device via the communication means.
